(19) United States
(12) Patent Application Publication
(10) Pub. No.: US 2026/0141233 A1
(43) Pub. Date: May 21, 2026

(54) MULTI-CHANNEL TIME SERIES ANALYSIS VIA A TRANSFORMER WITH A MULTI-VARIATE PARALLEL ATTENTION MODEL

(71) Applicant: International Business Machines Corporation, Armonk, NY (US)

(72) Inventors: Francesco Stefano Carzaniga, Aarau (CH); Michael Andreas Hersche, Zurich (CH); Abbas Rahimi, Rüschlikon (CH)

(21) Appl. No.: 18/953,577

(22) Filed: Nov. 20, 2024

(51) Int. Cl. G06N 3/08; G06N 3/045

(52) U.S. Cl. CPC G06N 3/08; G06N 3/045

(57) ABSTRACT

According to one embodiment of the present invention, a system for performing a prediction task or a classification task comprises one or more memories and at least one processor coupled to the one or more memories. The system generates a plurality of tokens from a plurality of multi-channel inputs. A plurality of embeddings is generated, via an encoder, from the plurality of tokens. The prediction task or the classification task is performed via a multi-variate parallel attention model based on the plurality of embeddings. The multi-variate parallel attention model is configured to determine a time-based attention, a channel-based attention, and a content-based attention in parallel. Embodiments of the present invention further include a method and computer program product for performing a prediction task or a classification task in substantially the same manner described above.

### BACKGROUND

### 1. Technical Field

Present invention embodiments relate to machine learning, and more specifically, to performing time series analysis of multi-channel input data via a transformer with a multi-variate parallel attention model configured to determine a time-based attention, a channel-based attention, and a content-based attention in parallel.

### 2. Discussion of the Related Art

Multi-channel input data (e.g., multi-variate time series data) may be analyzed to identify patterns and correlations that can be leveraged to generate predictions and inform decision-making. For example, multi-channel input data, such as electroencephalogram (EEG) records of neuronal activity, provide insightful information for monitoring brain conditions and detecting changes in brain activity. However, conventional transformer-based approaches struggle to generalize across heterogeneous data with varying numbers of channels since these models cannot process the time and space dimensions of multi-variate time series data simultaneously at the attention level. Further, conventional channel-independent approaches do not share information across the channels, while conventional channel-mixing approaches process time series in multiple steps. These approaches lack the ability to capture and integrate the temporal and spatial aspects of multi-variate time series data at the attention level to efficiently leverage a transformer-based model to generate accurate prediction and/or classification of multi-channel input data.

### SUMMARY

According to one embodiment of the present invention, a system for performing a prediction task or a classification task comprises one or more memories and at least one processor coupled to the one or more memories. The system generates a plurality of tokens from a plurality of multi-channel inputs. A plurality of embeddings is generated, via an encoder, from the plurality of tokens. The prediction task or the classification task is performed via a multi-variate parallel attention model based on the plurality of embeddings. The multi-variate parallel attention model is configured to determine a time-based attention, a channel-based attention, and a content-based attention in parallel. Embodiments of the present invention further include a method and computer program product for performing a prediction task or a classification task in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a flow diagram of performing a prediction task and/or a classification task by a transformer according to an embodiment of the present invention.

FIG. 3 is a diagrammatic illustration of tokenizing a multi-channel time series according to an embodiment of the present invention.

FIG. 4 is a flow diagram of performing a prediction task and/or a classification task via a multi-variate parallel attention model according to an embodiment of the present invention.

FIG. 5A is a diagrammatic illustration of generating a plurality of embeddings from a plurality of tokens via an encoder according to an embodiment of the present invention.

FIG. 5B is pseudocode providing an example of a manner of generating a plurality of embeddings from a plurality of tokens according to an embodiment of the present invention.

FIG. 6A is a diagrammatic illustration of generating one or more classification and/or prediction outputs from a plurality of embeddings via a multi-variate parallel attention model according to an embodiment of the present invention.

FIG. 6B is pseudocode providing an example of a manner of performing decoding in a multi-variate parallel attention model according to an embodiment of the present invention.

FIG. 6C is pseudocode providing an example of a manner for a multi-layer perceptron in a multi-variate parallel attention model according to an embodiment of the present invention.

FIG. 7A is a diagrammatic illustration of a self-attention mechanism for processing time series data according to an embodiment of the present invention.

FIG. 7B is pseudocode providing an example of a manner for implementing a multi-variate parallel attention model according to an embodiment of the present invention.

FIG. 7C is a diagrammatic illustration of comparing a structured dropout operation with a conventional dropout operation according to an embodiment of the present invention.

FIG. 7D is pseudocode providing an example of a manner for implementing a flash multi-variate parallel attention model according to an embodiment of the present invention.

FIG. 8A is a diagrammatic illustration of performing a prediction task via a multi-variate parallel attention model according to an embodiment of the present invention.

FIG. 8B is a diagrammatic illustration of training a multi-variate parallel attention model according to an embodiment of the present invention.

FIG. 8C is a diagrammatic illustration of performing a prediction task via a multi-variate parallel attention model based on testing data according to an embodiment of the present invention.

FIG. 8D is pseudocode providing an example of a manner for performing an inference task via a multi-variate parallel attention model according to an embodiment of the present invention.

### DETAILED DESCRIPTION

Multi-channel input data (e.g., multi-variate time series data) may be analyzed to identify patterns and correlations that can be leveraged to generate predictions and inform decision-making. For example, multi-channel input data, such as EEG records of neuronal activity, provide insightful information for monitoring brain conditions and detecting changes in brain activity. However, conventional transformer-based approaches struggle to generalize across heterogeneous data with varying numbers of channels since these models cannot process the time and space dimensions of multi-variate time series data simultaneously at the attention level. Further, conventional channel-independent approaches do not share information across the channels, while conventional channel-mixing approaches process time series in multiple steps. These approaches lack the ability to capture and integrate the temporal and spatial aspects of multi-variate time series data at the attention level to efficiently leverage a transformer-based model to generate accurate prediction and/or classification of multi-channel input data.

Accordingly, an embodiment of the present invention efficiently and accurately performs a prediction task or a classification task. The embodiment of the present invention leverages a transformer with a multi-variate parallel attention model to determine a time-based attention, a channel-based attention, and a content-based attention in parallel. A plurality of tokens is generated from a plurality of multi-channel inputs, and a plurality of embeddings is generated from the plurality of tokens. Based on the plurality of embeddings, the prediction task or classification task is performed via the multi-variate parallel attention model. The embodiment of the present invention further sums the time-based attention, the channel-based attention, and the content-based attention to determine an attention value to train the multi-variate parallel attention model. This provides a multi-variate parallel attention model that can effectively capture contextual information by simultaneously attending to time, channel, and content of input data, thus enabling enhanced performance of classification and/or prediction tasks and efficient use of computational resources.

Typically, EEG signal data may be collected from electrodes placed onto (scalp EEG) or into (intracranial EEG, or iEEG) a human brain. An embodiment of the present invention leverages a transformer with a multi-variate parallel attention model to generate prediction and/or classification of iEEG signal data (e.g., multi-channel time series data) indictive of brain activities. For example, the iEEG signal data may be divided into a plurality of temporal windows, and each temporal window is divided into a plurality of segments such that each segment is associated with a specific time and specific channel (e.g., an electrode). The plurality of segments is processed, via a feature extraction technique, to generate a plurality of tokens. The plurality of tokens is processed via an encoder to generate a plurality of embeddings representing the plurality of tokens. An embodiment of the present invention provides the plurality of embeddings to a multi-variate parallel attention model to simultaneously predict a next time series segment representing future neuronal activities and detect seizures. The multi-variate parallel attention model is configured to determine a time-based attention, a channel-based attention, and a content-based attention in parallel.

An embodiment of the present invention leverages a transformer with a multi-variate parallel attention model to perform a prediction task or a classification task. A plurality of multi-channel inputs is divided into a plurality of temporal windows each including a subset of the plurality of multi-channel inputs associated with a time. The plurality of temporal windows is divided into a plurality of segments each associated with a channel represented in the plurality of multi-channel inputs. The multi-variate parallel attention model is configured to determine a time-based attention, a channel-based attention, and a content-based attention in parallel. The time-based attention is determined based on temporal distances between each of the plurality of segments and other segments of the plurality of segments. The channel-based attention is determined based on spatial distances between each of the plurality of segments and the other segments. The content-based attention is determined by applying a self-attention mechanism to the plurality of segments. A multi-variate parallel attention model is configured to determine the time-based attention, the channel-based attention, and the content-based attention in parallel.

According to an aspect of the invention, there is provided a method of performing a prediction task or a classification task. At least one processor generates a plurality of tokens from a plurality of multi-channel inputs. The at least one processor, via an encoder, generates a plurality of embeddings from the plurality of tokens. The at least one processor, via a multi-variate parallel attention model, performs the prediction task or the classification task based on the plurality of embeddings. The multi-variate parallel attention model is configured to determine a time-based attention, a channel-based attention, and a content-based attention in parallel.

This provides an enhanced attention model that can efficiently and accurately generate prediction and/or classification of multi-channel input data. By leveraging a multi-variate parallel attention model configured to determine a time-based attention, a channel-based attention, and a content-based attention in parallel, a present invention embodiment reduces computational complexity associated with transformer-based analysis of multi-variate time series. This alleviates intractability issues and overcomes computational roadblocks associated with processing heterogeneous data of varying length and dimension, thus resulting in more efficient use of computational resources and higher computational performance. Further, a present invention embodiment provides a multi-variate parallel attention model that can effectively capture contextual information by simultaneously attending to time, channel, and content of input data, thus enabling enhanced performance of classification and/or prediction tasks.

In embodiments, the plurality of multi-channel inputs includes multi-channel time series data and generating the plurality of tokens comprises dividing the plurality of multi-channel inputs into a plurality of temporal windows each including a subset of the plurality of multi-channel inputs associated with a time, dividing each of the plurality of temporal windows into a plurality of segments each associated with a channel represented in the plurality of multi-channel inputs, and processing, via a feature extraction technique, the plurality of segments to generate the plurality of tokens. This provides an enhanced attention model that can efficiently and accurately generate prediction and/or classification of multi-channel input data.

In embodiments, the at least one processor further trains the multi-variate parallel attention model to simultaneously perform the prediction task and the classification task, wherein the prediction task includes predicting one or more data points following the plurality of multi-channel inputs and the classification task includes classifying a category associated with the plurality of multi-channel inputs. This provides an enhanced attention model that can efficiently and accurately generate prediction and classification of multi-channel input data.

In embodiments, training the multi-variate parallel attention model comprises summing the time-based attention, the channel-based attention, and the content-based attention to determine an attention value to train the multi-variate parallel attention model. This provides an enhanced attention model that can efficiently and accurately generate prediction and classification of multi-channel input data. Further, a present invention embodiment provides a multi-variate parallel attention model that can effectively capture contextual information by simultaneously attending to time, channel, and content of input data, thus enabling enhanced performance of classification and/or prediction tasks.

In embodiments, the multi-variate parallel attention model includes a decoder and a multi-layer perceptron. This provides an enhanced attention model that can efficiently and accurately generate prediction and classification of multi-channel input data.

In embodiments, the time-based attention is determined based on temporal distances between each of the plurality of segments and other segments of the plurality of segments, the channel-based attention is determined based on spatial distances between each of the plurality of segments and the other segments, the content-based attention is determined by applying a self-attention mechanism to the plurality of segments, the temporal distances are stored in a temporal positional codebook, and the spatial distances are stored in a spatial positional codebook. This provides an enhanced attention model that can efficiently and accurately generate prediction and/or classification of multi-channel input data.

In embodiments, one of the plurality of tokens is randomly selected as a question token representing a classification objective and one or more of the plurality of tokens are selected as answer tokens representing classification outputs. This provides an enhanced attention model that can efficiently and accurately generate prediction and/or classification of multi-channel input data.

According to an aspect of the invention, there is provided a computer system for performing a prediction task or a classification task comprising a processor set, one or more computer-readable storage media, and program instructions stored on the one or more computer-readable storage media to cause the processor set to perform operations. The program instructions cause the processor set to generate a plurality of tokens from a plurality of multi-channel inputs. The program instructions cause the processor set to generate, via an encoder, a plurality of embeddings from the plurality of tokens. The program instructions cause the processor set to perform, via a multi-variate parallel attention model, the prediction task or the classification task based on the plurality of embeddings. The multi-variate parallel attention model is configured to determine a time-based attention, a channel-based attention, and a content-based attention in parallel.

This provides an enhanced attention model that can efficiently and accurately generate prediction and/or classification of multi-channel input data. By leveraging a multi-variate parallel attention model configured to determine a time-based attention, a channel-based attention, and a content-based attention in parallel, a present invention embodiment reduces computational complexity associated with transformer-based analysis of multi-variate time series. This alleviates intractability issues and overcomes computational roadblocks associated with processing heterogeneous data of varying length and dimension, thus resulting in more efficient use of computational resources and higher computational performance. Further, a present invention embodiment provides a multi-variate parallel attention model that can effectively capture contextual information by simultaneously attending to time, channel, and content of input data, thus enabling enhanced performance of classification and/or prediction tasks.

In embodiments of the computer system, the plurality of multi-channel inputs includes multi-channel time series data and generating the plurality of tokens comprises dividing the plurality of multi-channel inputs into a plurality of temporal windows each including a subset of the plurality of multi-channel inputs associated with a time, dividing each of the plurality of temporal windows into a plurality of segments each associated with a channel represented in the plurality of multi-channel inputs, and processing, via a feature extraction technique, the plurality of segments to generate the plurality of tokens. This provides an enhanced attention model that can efficiently and accurately generate prediction and/or classification of multi-channel input data.

In embodiments of the computer system, the program instructions further cause the processor set to train the multi-variate parallel attention model to simultaneously perform the prediction task and the classification task, wherein the prediction task includes predicting one or more data points following the plurality of multi-channel inputs and the classification task includes classifying a category associated with the plurality of multi-channel inputs. This provides an enhanced attention model that can efficiently and accurately generate prediction and classification of multi-channel input data.

In embodiments of the computer system, training the multi-variate parallel attention model comprises summing the time-based attention, the channel-based attention, and the content-based attention to determine an attention value to train the multi-variate parallel attention model. This provides an enhanced attention model that can efficiently and accurately generate prediction and classification of multi-channel input data. Further, a present invention embodiment provides a multi-variate parallel attention model that can effectively capture contextual information by simultaneously attending to time, channel, and content of input data, thus enabling enhanced performance of classification and/or prediction tasks.

In embodiments of the computer system, the multi-variate parallel attention model includes a decoder and a multi-layer perceptron. This provides an enhanced attention model that can efficiently and accurately generate prediction and classification of multi-channel input data.

In embodiments of the computer system, the time-based attention is determined based on temporal distances between each of the plurality of segments and other segments of the plurality of segments, the channel-based attention is determined based on spatial distances between each of the plurality of segments and the other segments, the content-based attention is determined by applying a self-attention mechanism to the plurality of segments, the temporal distances are stored in a temporal positional codebook, and the spatial distances are stored in a spatial positional codebook. This provides an enhanced attention model that can efficiently and accurately generate prediction and/or classification of multi-channel input data.

In embodiments of the computer system, one of the plurality of tokens is randomly selected as a question token representing a classification objective and one or more of the plurality of tokens are selected as answer tokens representing classification outputs. This provides an enhanced attention model that can efficiently and accurately generate prediction and/or classification of multi-channel input data.

According to an aspect of the invention, there is provided a computer program product for performing a prediction task or a classification task. The computer program product comprises one or more computer-readable storage media and program instructions stored on the one or more computer-readable storage media to perform operations. The operations comprise generating a plurality of tokens from a plurality of multi-channel inputs. The operations comprise generating, via an encoder, a plurality of embeddings from the plurality of tokens. The operations comprise performing, via a multi-variate parallel attention model, the prediction task or the classification task based on the plurality of embeddings. The multi-variate parallel attention model is configured to determine a time-based attention, a channel-based attention, and a content-based attention in parallel.

This provides an enhanced attention model that can efficiently and accurately generate prediction and/or classification of multi-channel input data. By leveraging a multi-variate parallel attention model configured to determine a time-based attention, a channel-based attention, and a content-based attention in parallel, a present invention embodiment reduces computational complexity associated with transformer-based analysis of multi-variate time series. This alleviates intractability issues and overcomes computational roadblocks associated with processing heterogeneous data of varying length and dimension, thus resulting in more efficient use of computational resources and higher computational performance. Further, a present invention embodiment provides a multi-variate parallel attention model that can effectively capture contextual information by simultaneously attending to time, channel, and content of input data, thus enabling enhanced performance of classification and/or prediction tasks.

In embodiments of the computer program product, the plurality of multi-channel inputs includes multi-channel time series data and generating the plurality of tokens comprises dividing the plurality of multi-channel inputs into a plurality of temporal windows each including a subset of the plurality of multi-channel inputs associated with a time, dividing each of the plurality of temporal windows into a plurality of segments each associated with a channel represented in the plurality of multi-channel inputs, and processing, via a feature extraction technique, the plurality of segments to generate the plurality of tokens. This provides an enhanced attention model that can efficiently and accurately generate prediction and/or classification of multi-channel input data.

In embodiments of the computer program product, the operations further comprise training the multi-variate parallel attention model to simultaneously perform the prediction task and the classification task, wherein the prediction task includes predicting one or more data points following the plurality of multi-channel inputs and the classification task includes classifying a category associated with the plurality of multi-channel inputs. This provides an enhanced attention model that can efficiently and accurately generate prediction and classification of multi-channel input data.

In embodiments of the computer program product, training the multi-variate parallel attention model comprises summing the time-based attention, the channel-based attention, and the content-based attention to determine an attention value to train the multi-variate parallel attention model. This provides an enhanced attention model that can efficiently and accurately generate prediction and classification of multi-channel input data. Further, a present invention embodiment provides a multi-variate parallel attention model that can effectively capture contextual information by simultaneously attending to time, channel, and content of input data, thus enabling enhanced performance of classification and/or prediction tasks.

In embodiments of the computer program product, the multi-variate parallel attention model includes a decoder and a multi-layer perceptron. This provides an enhanced attention model that can efficiently and accurately generate prediction and classification of multi-channel input data.

In embodiments of the computer program product, the time-based attention is determined based on temporal distances between each of the plurality of segments and other segments of the plurality of segments, the channel-based attention is determined based on spatial distances between each of the plurality of segments and the other segments, the content-based attention is determined by applying a self-attention mechanism to the plurality of segments, the temporal distances are stored in a temporal positional codebook, and the spatial distances are stored in a spatial positional codebook. This provides an enhanced attention model that can efficiently and accurately generate prediction and/or classification of multi-channel input data.

In an example scenario, a multi-variate parallel attention model may be leveraged to generate prediction and/or classification of iEEG signal data (e.g., multi-channel time series data) representing brain activities. For example, the iEEG signal data may be divided into a plurality of temporal windows, each temporal window is divided into a plurality of segments such that each segment is associated with a specific time and specific channel (e.g., an electrode). The plurality of segments is processed, via a feature extraction technique, to generate a plurality of tokens. The plurality of tokens is processed via an encoder to generate a plurality of embeddings representing the plurality of tokens. An embodiment of the present invention provides the plurality of embeddings to a multi-variate parallel attention model to simultaneously predict a next time series segment representing future neuronal activities and detect seizures. An embodiment of the present invention provides a multi-variate parallel attention model configured to determine a time-based attention, a channel-based attention, and a content-based attention in parallel, thus reducing computational complexity and effectively capturing contextual information to enable enhanced performance of classification and prediction tasks.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

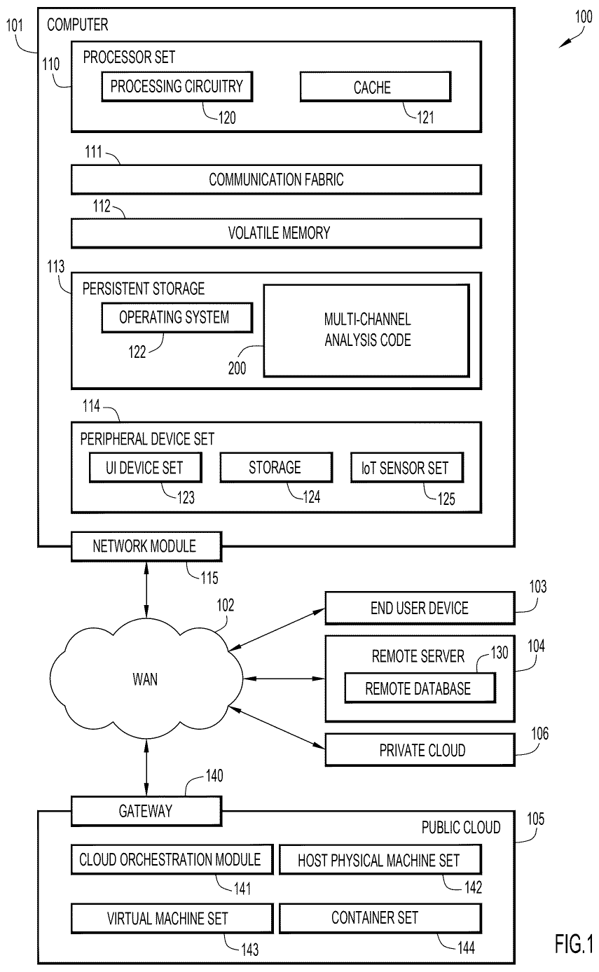

Referring to FIG. 1, computing environment 100 contains an example of an environment for the execution of at least some of the computer code involved in performing the inventive methods, such as multi-channel analysis code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): public and private clouds 105, 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offerings is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

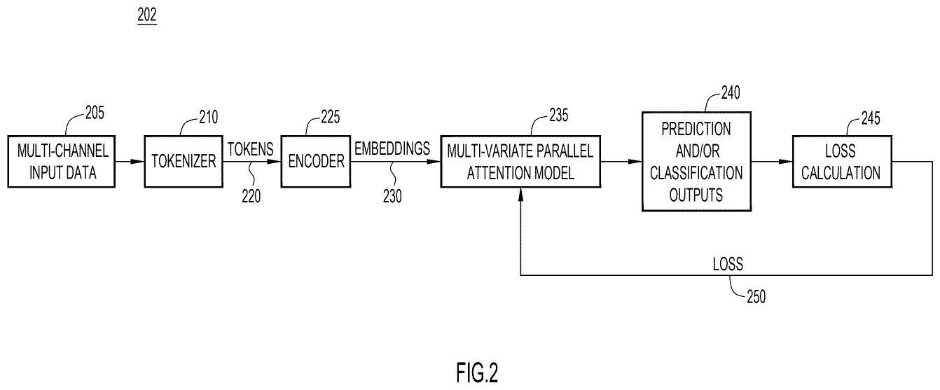

A flow diagram for a transformer 202 for performing a prediction task and/or a classification task (e.g., via multi-channel analysis code 200, computer 101, etc.) according to an embodiment of the present invention is illustrated in FIG. 2. Initially, multi-channel input data 205 is obtained. The multi-channel input data 205 may include multi-channel time series data. Multi-channel time series data includes a plurality of time series each having one or more dimensions. For example, multi-channel time series data may be multi-variate where one dimension of the data represents time, while one or more second dimensions represent variables that depend on time. For example, biosignals, such as electrical activities of the brain captured via EEG or electrical activities of the heart captured via electrocardiogram (ECG), may be represented as a multi-channel time series with a first dimension representing time and one or more second dimensions representing channels (e.g., electrodes). In another example, temperature and humidity data in a city over time may be represented as a multi-channel time series where temperature and humidity are channels with data that evolve over time. The multi-channel time series data may be fixed-length or varied-length. For example, varied-length multi-channel time series data may include a collection of time series each having a different number of time points.

Multi-channel input data 205 is provided as inputs to a tokenizer 210 of transformer 202. The tokenizer 210 may perform a two-dimensional (2D) tokenization procedure that converts multi-channel input data 205 into a plurality of one-dimensional (1D) vectors representing a plurality of tokens 220. For example, multi-channel time series data may be partitioned, via the 2D tokenization procedure, to generate a plurality of segments of time series data representing the plurality of tokens 220. The plurality of tokens 220 is provided as input to an encoder 225 of transformer 202 to generate one or more embeddings 230. The one or more embeddings 230 are provided to a multi-variate parallel attention model 235 of transformer 202 to generate one or more prediction and/or classification outputs 240. The one or more prediction and/or classification outputs 240 are compared with actual outputs (e.g., ground truth values) at loss calculation operation 245 to determine a loss 250. The loss 250 may be iteratively optimized to train the multi-variate parallel attention model 235 until a stopping criterion is met. The stopping criterion may be based on model performance, number of iterations, or any suitable criterion defined and/or configured by a user.

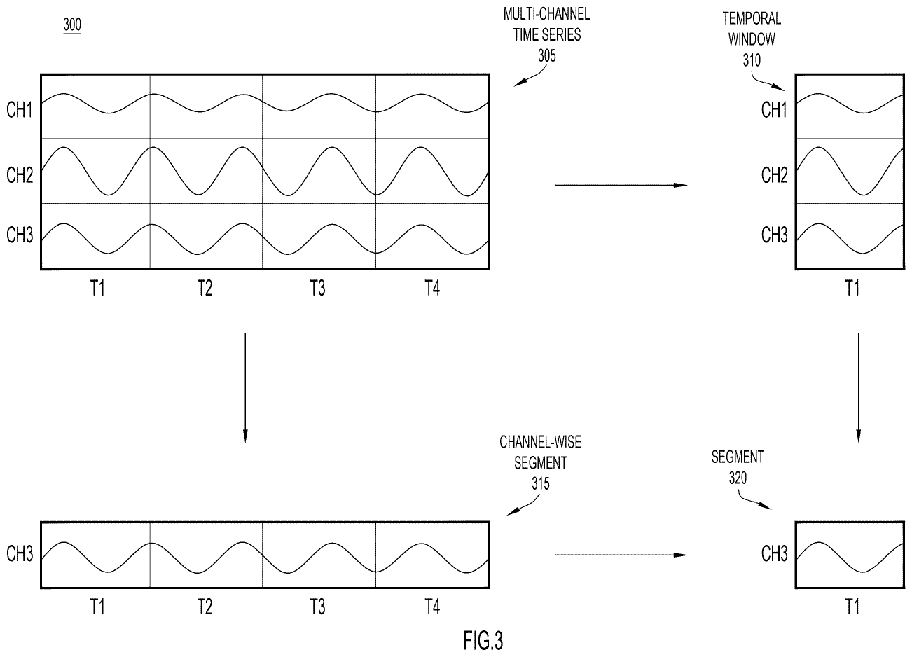

A tokenization procedure 300 leveraged to generate a plurality of tokens from a multi-channel time series 305 (e.g., via multi-channel analysis code 200, computer 101, etc.) according to an embodiment of the present invention is illustrated in FIG. 3. Multi-channel time series 305 may be represented by a 2D matrix of independent segments that can be converted into a plurality of 1D vectors. Initially, multi-channel time series 305 is partitioned into a plurality of temporal windows. Each temporal window includes a subset of the data in multi-channel time series 305 that corresponds to all channels associated with a specific time. For example, a temporal window 310 extracted from multi-channel time series 305 includes data from channel 1 (“CH1”), channel 2 (“CH2”), and channel 3 (“CH3”) at time T1. Further, the multi-channel time series 305 may be partitioned into a plurality of channel-wise segments. Each channel-wise segment includes a subset of the data in multi-channel time series 305 that corresponds to one specific channel at all time points. For example, a channel-wise segment 315 extracted from multi-channel time series 305 includes data from CH3 at all time points (e.g., T1, T2, T3, T4, etc.).

Each temporal window (e.g., temporal window 310) is partitioned to generate a plurality of segments. Each of the plurality of segments corresponds to data in multi-channel time series 305 that is associated with a specific time and a specific channel. For example, temporal window 310 is partitioned channel-wise into a plurality of segments, such as a segment 320 that includes time series data associated with CH3 at T1. By way of example, multi-channel time series 305 may be partitioned into a plurality of segments T1-CH1, T1-CH2, T1-CH3, T2-CH1, . . . , T4-CH3. Each segment is considered a token that may be processed by a model (e.g., large language model). The tokenization procedure is applied channel-wise, meaning each segment remains one dimensional. Each channel is processed via the tokenization procedure independently and in parallel, thus significantly reducing the computational complexity. In certain embodiments, one or more segments may be extracted from the plurality of channel-wise segments (e.g., channel-wise segment 315).

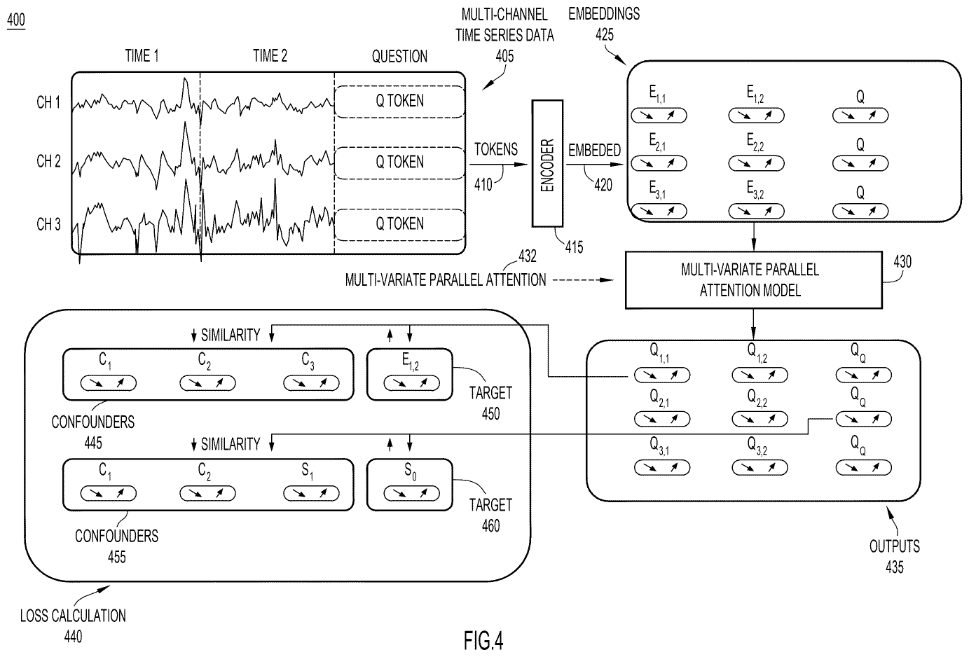

A method 400 to perform a prediction task and/or a classification task via a transformer with a multi-variate parallel attention model (e.g., via multi-channel analysis code 200, computer 101, etc.) according to an embodiment of the present invention is illustrated in FIG. 4. Initially, multi-channel time series data 405 is obtained. For example, multi-channel time series data 405 may include a collection of time series each corresponding to a specific channel. The multi-channel time series data 405 may be tokenized via a tokenization procedure (e.g., tokenization procedure 300) to generate a plurality of tokens (e.g., 1D vectors) representing a plurality of segments of multi-channel time series data 405. For each time series in multi-channel time series data 405, a token (e.g., 1D vector) may be randomly selected as a question token (or “Q token”) and appended to the tokens representing the time series (e.g., signal data). The question token represents a classification objective associated with a classification task. For example, the classification task of seizure detection may be performed on multi-channel time series data 405 (e.g., intracranial electroencephalography (iEEG) signals) with the classification objective of detecting seizure onset times. Further, a plurality of 1D vectors is selected to represent a plurality of answer tokens representing possible classification outputs. The plurality of tokens representing multi-channel time series data 405, along with a plurality of question tokens, form a plurality of tokens 410 that are provided as inputs to an encoder 415 of the transformer. The output corresponding to each token representing a data point in a time series is the next token in the time series. The output corresponding to a question token is an answer token indicating a classification output (e.g., absence or presence of seizure).

At an embed operation 420, the encoder 415 generates a plurality of embeddings 425 based on the plurality of tokens 410. The plurality of tokens 410 is provided as an input to encoder 415 configured to apply a feature extraction procedure to generate a plurality of feature vectors. The feature extraction procedure may be implemented by any conventional techniques and/or models, including wavelet composition, a convolutional neural network, a multi-layer perceptron, etc. In certain embodiments, each of the plurality of feature vectors is projected to a lower-dimension subspace to ensure efficient processing. For example, each segment (represented by a token) extracted from a temporal window is passed independently through a wavelet decomposition which, depending on an overall model size, is then linearly projected onto a smaller space. This projection, or feature vector, produces an embedding corresponding to each of the plurality of tokens 410, thus forming the plurality of embeddings 425.

The plurality of embeddings 425 is provided as input to a multi-variate parallel attention model 430 of the transformer configured to perform a classification and/or prediction task. The multi-variate parallel attention model 430 may be implemented via a multi-variate parallel attention 432 configured to determine a time-based attention, a channel-based attention, and a content-based attention in parallel. A plurality of outputs 435 is generated by multi-variate parallel attention model 430. The output corresponding to each token representing a data point in a time series is the next token in the time series. The output corresponding to a question token is an answer token indicating a classification output (e.g., absence or presence of seizure). In addition to performing a classification task, the multi-variate parallel attention model 430 may perform a prediction task, such as predicting a time series segment representing future neuronal activities (e.g., iEEG signals). In certain embodiments, the multi-variate parallel attention model 430 may perform the classification task and the prediction task simultaneously.

The plurality of outputs 435 is compared to a plurality of target outputs (“targets”) and a plurality confounding outputs (“confounders”) at loss calculation 440. A target output refers to an actual output given a dataset. For example, in a prediction task performed by multi-variate parallel attention model 430 to predict future time series segments, a predicted output O_{1,1} (e.g., output associated with channel 1 at time 1) of the plurality of outputs 435 may be compared to a target 450, such as a target embedding E_{1,2} (e.g., embedding associated with channel 1 at time 2). A predicted output O_{Q} (e.g., output associated with a question token) may be compared to a target 460. A plurality of confounders may be selected for each of the plurality of outputs 435. For example, a plurality of confounders 445 corresponds to predicted output O_{1,1} and a plurality of confounders 455 corresponds to predicted output O_{Q}.

A plurality of temporal windows may be selected from multi-channel time series data 405 to form a batch of temporal windows. A plurality of input segments is randomly sampled from the batch of temporal windows to generate a plurality of confounders, including the plurality of confounders 445 and the plurality of confounders 455. The sampled input segments (e.g., confounders 445 and confounders 455) represent actual data from multi-channel time series data 405 (e.g., actual iEEG signals) that are expected to be very different from the true target to strike a balance between too much and too little similarity between the cofounders and the plurality of outputs 435.

The plurality of confounders 445 and the plurality of confounders 455 are provided for loss calculation 440. Predicted outputs (e.g., plurality of outputs 435) may be compared to actual outputs (e.g., target 450 and target 460) and to confounders (e.g., the plurality of confounders 445 and the plurality of confounders 455) to determine a contrastive loss. The contrastive loss is configured to increase a cosine similarity of predicted outputs with true targets, while decreasing the cosine similarity of predicted outputs with confounding targets. Based on the contrastive loss, multi-variate parallel attention model 430 is iteratively optimized as training progresses to produce predicted outputs that look like encoded segments (e.g., inputs to multi-variate parallel attention model 430). Multi-variate parallel attention model 430 becomes more and more capable of choosing the right target and thus is able to predict the future token (e.g., signal).

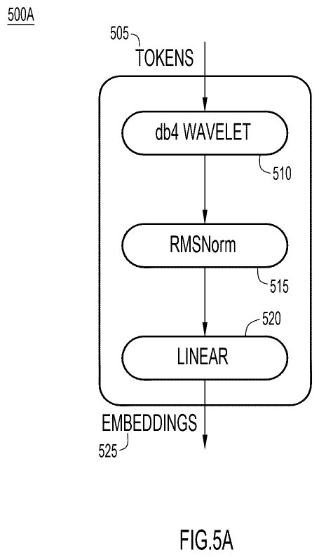

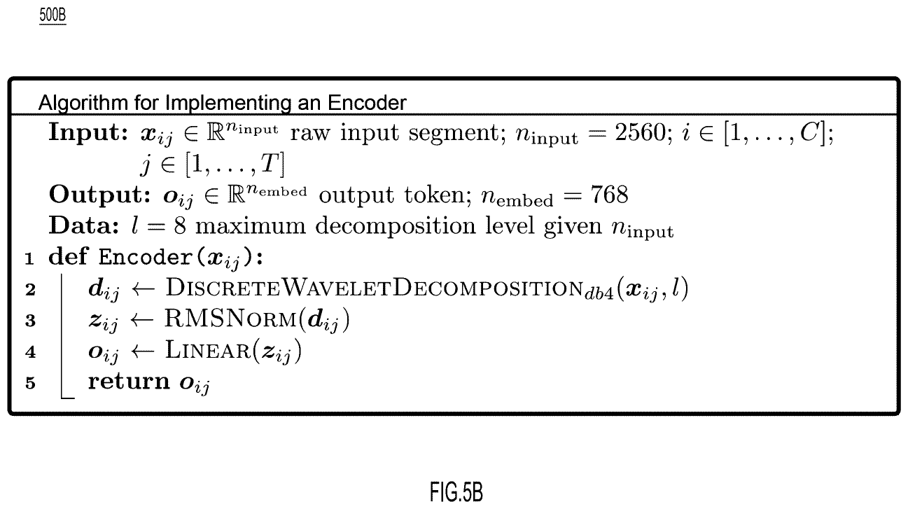

An encoder 500A configured to generate a plurality of embeddings from a plurality of tokens (e.g., via multi-channel analysis code 200, computer 101, etc.) according to an embodiment of the present invention is illustrated in FIG. 5A. A plurality of tokens 505 representing a plurality of segments of a multi-channel input data (e.g., multi-channel time series data) is provided as input to encoder 500A including a first layer configured to perform a Daubechies 4 wavelet (db4) wavelet operation 510, a second layer configured to perform a Root Mean Square Layer Normalization (RMSNorm) operation 515, and a third layer for performing a linear operation 520 (e.g., a linear layer). A subset of the plurality of tokens 505 representing a specific segment in the multi-channel time series data passes independently through encoder 500A. Initially, each subset of the plurality of tokens 505 is processed via db4 wavelet operation 510 (e.g., a db4 wavelet decomposition) to dynamically preserve both high and low frequencies of the multi-channel time series data (e.g., iEEG signals) with varying resolution. For example, wavelet decomposition may be used to preserve high frequency oscillations, which represent a crucial aspect of iEEG signals.

Outputs from the db4 wavelet operation 510 are processed by the RMSNorm operation 515, which includes normalizing activations by dividing activations by their root mean square values. Then, outputs from the RMSNorm operation 515 are linearly projected to a lower-dimension space at linear operation 520 resulting in a plurality of feature vectors representing a plurality of embeddings 525. The processing (e.g., operations 510, 515, and 520) is repeated for each segment in a specific temporal window, thus forming the plurality of embeddings 525 that may be provided as input to a transformer-based model. The transformer-based model may leverage any transformer architecture configured to generate classification and/or prediction of input data. The transformer-based architecture (e.g. LLama2 architecture) may provide a generative model powerful enough to process brain iEEG signals and computationally light enough to enable extensive testing. For example, the transformer-based architecture may include millions of parameters (e.g., 75 million parameters). The plurality of embeddings 525 may be learnable embeddings, or in other words, a conversion of high-dimension data into low-dimension data while preserving important characteristics of the data.

Pseudocode 500B providing an example manner for generating a plurality of embeddings from a plurality of tokens (e.g., via multi-channel analysis code 200, computer 101, etc.) according to an embodiment of the present invention is illustrated in FIG. 5B. The example algorithm of pseudocode 500B for implementing an encoder may take as input a plurality of raw input segments of a time series (e.g., multi-channel time series). Each segment x_{i,j} from the plurality of raw input segments (e.g., number of inputs nᵢₙₚₙₜ=2560) may be associated with an index i indicating a channel C, and an index j indicating a time C. Based on the plurality of raw input segments and a predetermined number of maximum decomposition level 1, the algorithm of pseudocode 500B generates a plurality of output tokens, each output token o_{i,j} may be represented by each of a plurality of embeddings. For example, the plurality of embeddings n_{embed}=768. First, each segment x_{i,j} and the number of maximum decomposition level l are provided as inputs to a db4 discrete wavelet decomposition operation, resulting in a decomposition output d_{i,j}. Then, the decomposition output d_{i,j} is provided as input to an RMSNorm operation, which generates a normalization output z_{i,j}. The normalization output z_{i,j} is provided as input to a linear operation, which generates the output tokens o_{i,j}. The output tokens o_{i,j} is the result returned by the algorithm of pseudocode 500B.

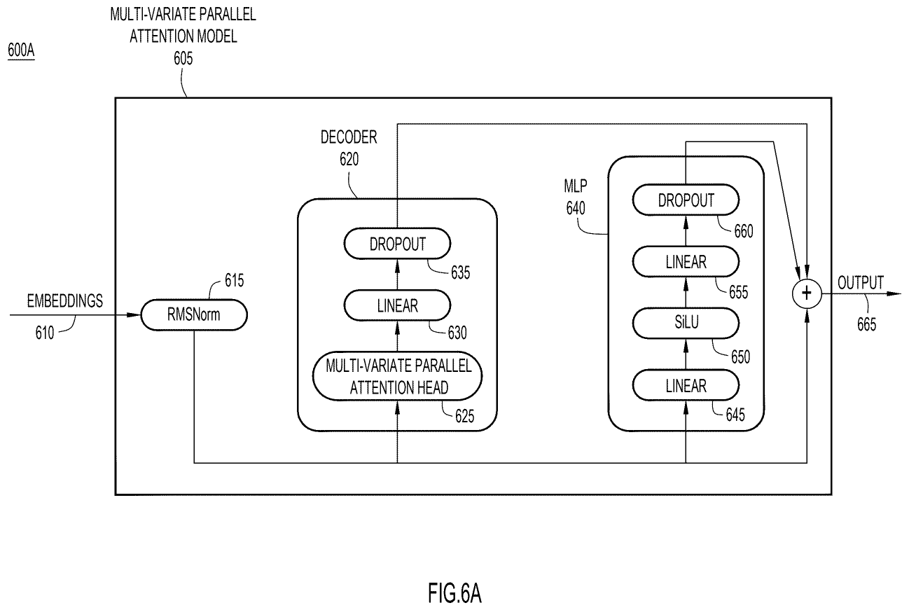

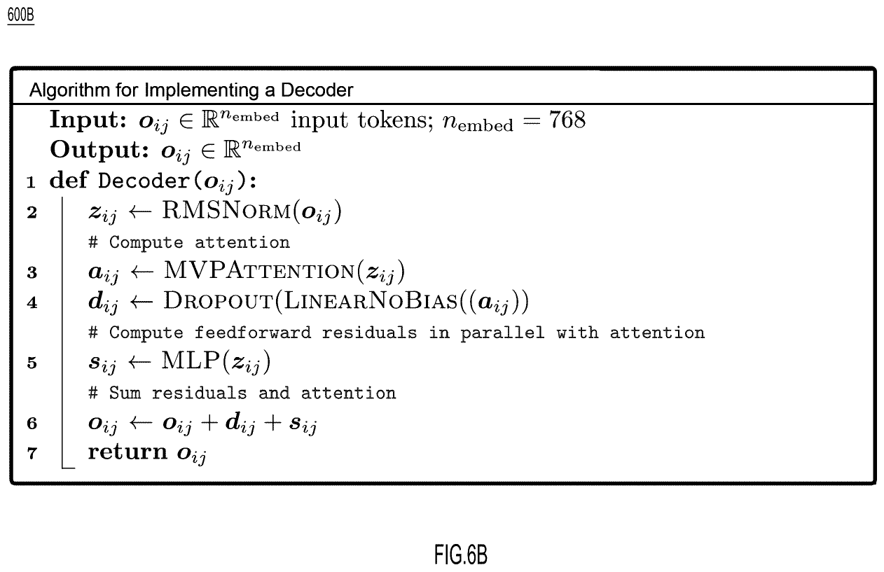

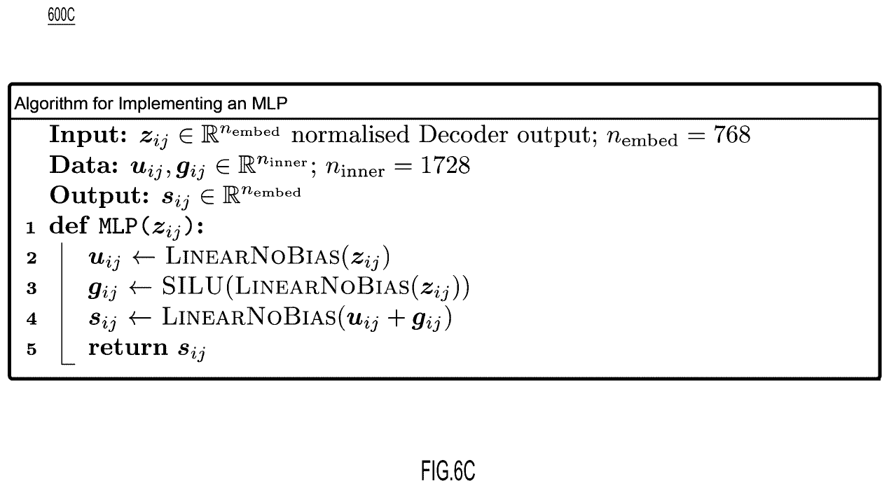

A system 600A for generating one or more classification and/or prediction outputs from a plurality of embeddings via a transformer with a multi-variate parallel attention model (e.g., via multi-channel analysis code 200, computer 101, etc.) according to an embodiment of the present invention is illustrated in FIG. 6A. The system 600A includes a multi-variate parallel attention model 605 of a transformer. Initially, a plurality of embeddings 610 (e.g., embeddings generated by encoder 500A) is provided as input to multi-variate parallel attention model 605 of the transformer. The multi-variate parallel attention model 605 includes a layer configured to perform a RMSNorm operation 615 and a decoder 620 (e.g., a transformer). The plurality of embeddings 610 is processed by RMSNorm operation 615, which includes normalizing activations by dividing the activations by their root mean square values. Outputs from RMSNorm operation 615 are provided to decoder 620, which includes a multi-variate parallel attention head 625, a layer configured to perform a linear operation 630, and a layer configured to perform a dropout operation 635.

The multi-variate parallel attention head 625 is configured to determine a time-based attention, a channel-based attention, and a content-based attention in parallel. The time-based attention, channel-based attention, and content-based attention may be combined to generate an attention value for a self-attention mechanism that enables multi-variate parallel attention model 605 to focus on different context relationships within an input. The multi-variate parallel attention model 605 may be a transformer-based model that can effectively capture context information, thus enabling state-of-the-art performance in many tasks (e.g., classification and/or prediction tasks). For example, multi-variate parallel attention head 625 helps break down the structure of the input (e.g., plurality of embeddings 610) and better understand the input.

Outputs from multi-variate parallel attention head 625 are processed through linear operation 630 and dropout operation 635. The dropout operation 635 may be a technique to improve the generalization performance of neural networks and transformers. For example, dropout is often applied inside an attention block (e.g., decoder 620) to randomly zero-out some query-key attentions to avoid over-reliance of a model on specific connections. The dropout operation 635 may be a structured dropout technique configured to blank entire channels and time points instead of individual segments.

The multi-variate parallel attention model 605 further includes a multi-layer perceptron (MLP) 640. The plurality of embeddings 610, after being processed by RMSNorm operation 615, is provided to decoder 620 and multi-layer perceptron 640 in parallel, thus resulting in a speed-up when compared to sequential processing through the decoder 620 and multi-layer perceptron 640. The multi-layer perceptron 640 includes a layer configured to perform a first linear operation 645, a sigmoid linear unit (SiLU) 650, a layer configured to perform a second linear operation 655, and a layer configured to perform a dropout operation 660. Outputs from RMSNorm operation 615 are processed by first linear operation 645 (e.g., a linear transformation that maps input data to output data). Then, outputs of first linear operation 645 are processed by SiLU 650, an activation function computed by a sigmoid function multiplied by its inputs. Then, another linear operation (e.g., second linear operation 655) is performed on outputs from SiLU 650 and the resulting outputs are processed by dropout operation 660, which may be a structured dropout technique. Outputs from RMSNorm operation 615, decoder 620 and multi-layer perceptron 640 are combined to form an output 665 of a classification and/or prediction task.

Pseudocode 600B providing an example manner for implementing a decoder (e.g., via multi-channel analysis code 200, computer 101, etc.) according to an embodiment of the present invention is illustrated in FIG. 6B. The algorithm of pseudocode 600B for implementing a decoder may take as input a plurality of output tokens, each output token o_{i,j} may be represented by each of a plurality of embeddings. For example, the plurality of embeddings n_{embed}=768. The algorithm of pseudocode 600B includes a RMSNorm operation, which takes an output token o_{i,j} as input to generate a normalization output z_{i,j}. Then, the algorithm of pseudocode 600B is configured to compute an attention value using a multi-variate parallel attention (MVPA) mechanism. The normalized decoder output z_{i,j} is provided as input to a multi-variate parallel attention operation, which computes an attention value a_{i,j}. The attention value a_{i,j} is provided as input to a linear operation with no bias and to a dropout operation to generate an attention output d_{i,j}. Feedforward residuals may be computed in parallel with the attention. For example, normalized decoder output z_{i,j} may be provided as input to a multi-layer perceptron to generate a feedforward residual s_{i,j}. Then, the output token o_{i,j}, the attention output d_{i,j}, and the feedforward residual s_{i,j} are summed to generate a decoded output token o_{i,j}. The decoded output tokens o_{i,j} is the result returned by the algorithm of pseudocode 600B.

Pseudocode 600C providing an example manner for implementing a multi-layer perceptron (e.g., via multi-channel analysis code 200, computer 101, etc.) according to an embodiment of the present invention is illustrated in FIG. 6C. The algorithm of pseudocode 600C for implementing a multi-layer perceptron may take as input a plurality of normalized decoder outputs, each normalized decoder output z_{i,j} is associated with each of a plurality of embeddings (e.g., n_{embed}=768). Based on the normalized decoder output z_{i,j}, the algorithm of pseudocode 600C is configured to generate as output a feedforward residual s_{i,j}. The normalized decoder output z_{i,j} is processed by a linear operation with no bias to generate an output u_{i,j}. The output u_{i,j} (e.g., output of processing normalized decoder output z_{i,j} by a linear operation with no bias) is processed by a sigmoid linear unit to generate an output g_{i,j}. The output u_{i,j} and output g_{i,j} are associated with a number of inner products nᵢₙₙₑᵣ=1728. The sum of output u_{i,j} and output g_{i,j} is processed by a linear operation with no bias to generate as output a feedforward residual s_{i,j}. The feedforward residual s_{i,j} is the result returned by the algorithm of pseudocode 600C.

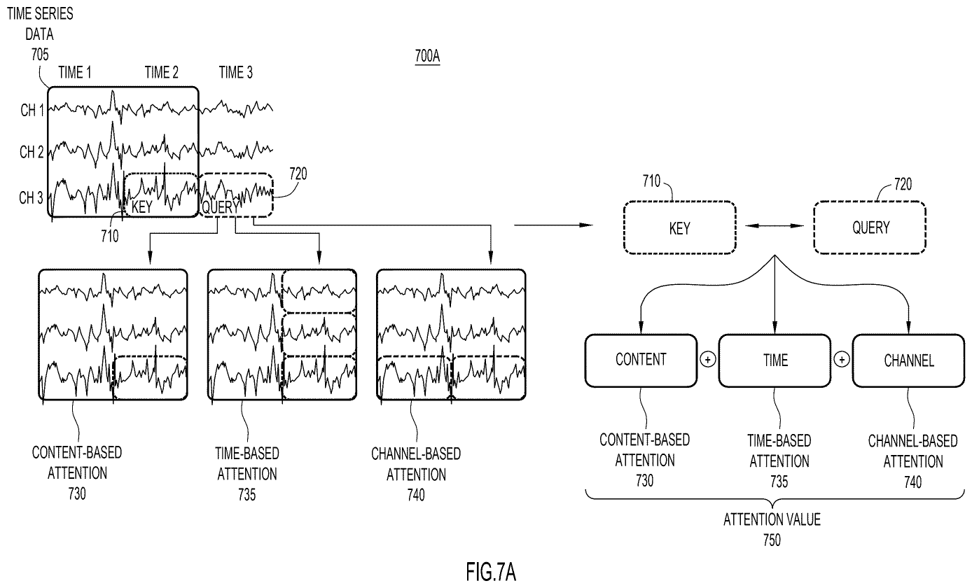

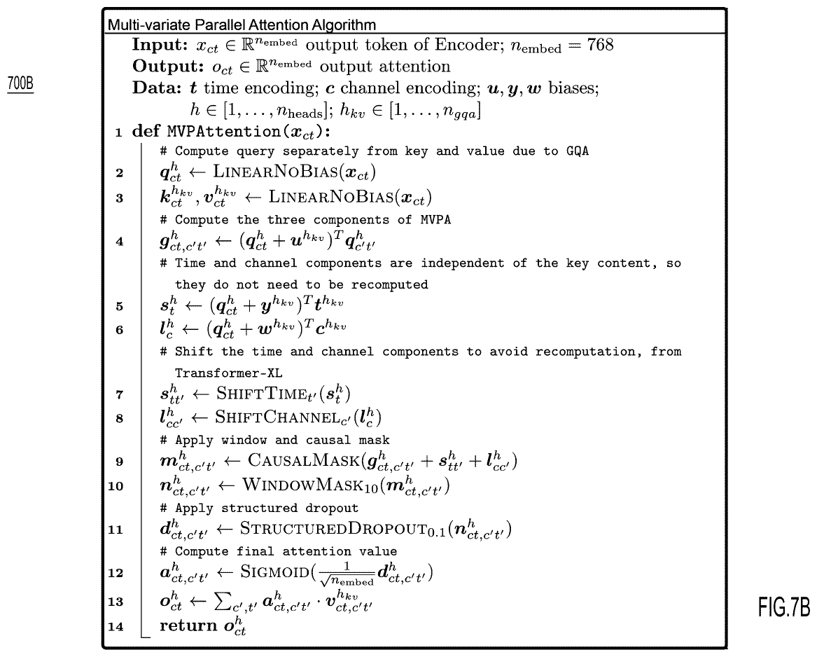

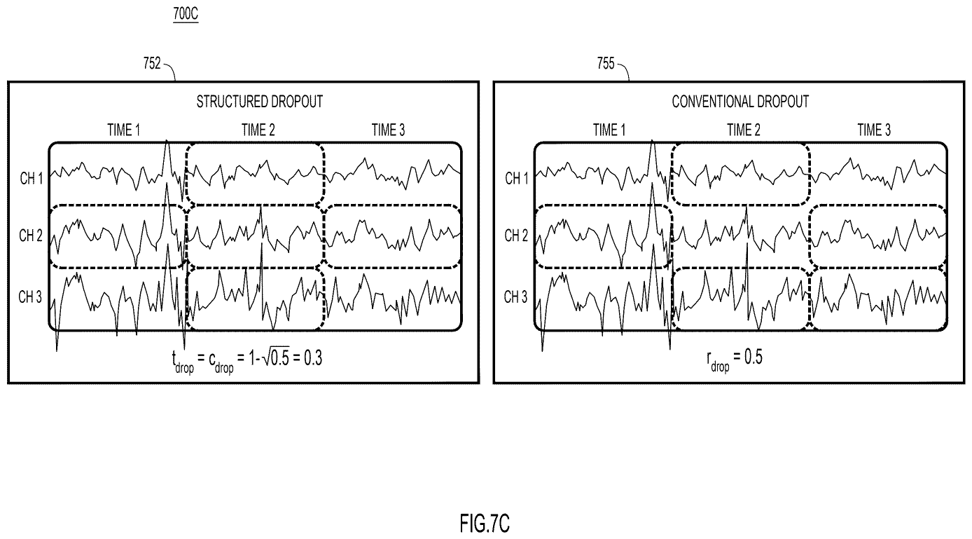

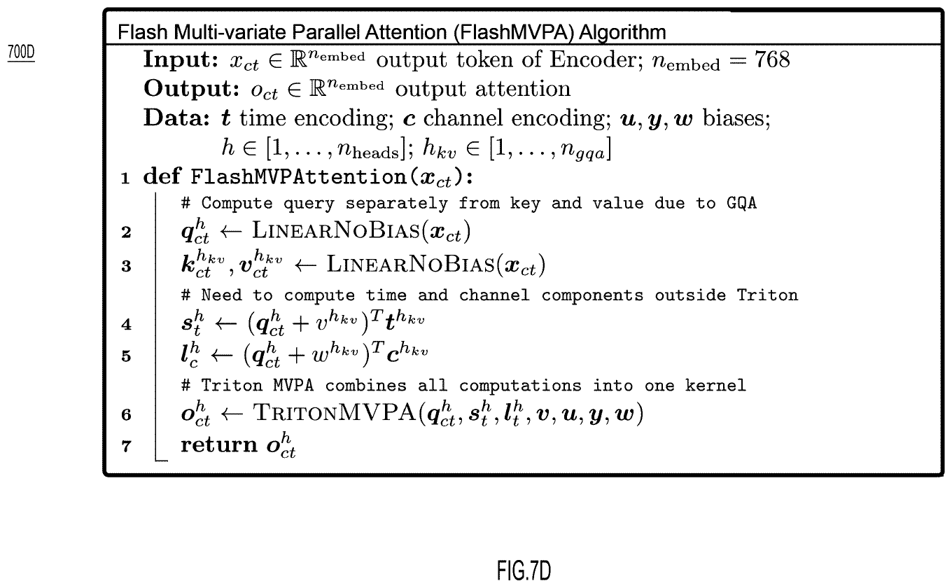

A self-attention mechanism 700A for processing time series data (e.g., via multi-channel analysis code 200, computer 101, etc.) according to an embodiment of the present invention is illustrated in FIG. 7A. A multi-variate parallel attention model of a transformer may leverage self-attention mechanism 700A (e.g., a multi-variate parallel attention mechanism) to generate one or more classification and/or prediction outputs based on an input time series. Initially, time series data 705 (e.g., multi-channel time series) is processed to select a first segment of time series that serves as a key 710 and a second segment of time series that serves as a query 720. The query 720, represented by a self-attention head, may be divided into three components, including a content-based attention 730, a time-based attention 735, and a channel-based attention 740. The content-based attention 730 is configured to determine an attention that focuses on one or more characteristics of the content (e.g., frequency of time series data 705). The time-based attention 735 is configured to determine an attention based on a time component of the time series data 705. For example, the time-based attention 735 may be determined based on temporal distances between each segment in time series data 705 and other segments in time series data 705. The channel-based attention 740 is configured to determine an attention based on a channel, or space, component of time series data 705. For example, the channel-based attention 740 may be determined based on spatial distances between each segment in time series data 705 and other segments in time series data 705. The channel-based attention 740 may be determined by applying a self-attention mechanism to the plurality of segments without positional encoding. The content-based attention 730, time-based attention 735, and channel-based attention 740 may be summed to generate an attention value 750 for self-attention mechanism 700A.

The self-attention mechanism 700A may be implemented using one multi-purpose head configured to determine multiple attentions (e.g., time, channel, content, etc.) in parallel instead of using multiple heads each focusing on one specific type of attention. Thus, transformer-based models (e.g., multi-variate parallel attention model 430) leveraging self-attention mechanism 700A may achieve subquadratic complexity compared to conventional techniques (e.g., using conventional attention mechanisms) and provide improved memory efficiency. In an exemplary embodiment, transformer-based models (e.g., multi-variate parallel attention model 430) leveraging self-attention mechanism 700A may achieve 3.5 times speedup in processing time compared to that of conventional techniques.

Each of the content-based attention 730, time-based attention 735, and channel-based attention 740 attends to a different aspect of a signal represented in time series data 705 (e.g., iEEG signal data). Time series data 705 may be represented as a 2D collection of segments each associated with a different location in time and space (e.g., the channels). The 2D structure of the collection of segments may be preserved by identifying each segment with two separate indices, c for space and t for time. This representation introduces a priori knowledge about the structure of the signal into self-attention mechanism 700A and enables seamless processing of input data that have a different number of channels without confusing the model (e.g., a multi-variate parallel attention model).

An exemplary conventional attention mechanism may be expressed as

$${A}_{i , j} = {( {X}_{i} + S\_i )}^{T} {W}_{q}^{T} {W}_{k}^{T} ( {X}_{j} + S\_i ) , \qquad Equation 1$$

wherein A_{i,j} represents an attention value at index i and j, X represents an input (e.g., embeddings of time series data 705),

$${W}_{q}^{T}$$

represents the query matrix,

$${W}_{k}^{T}$$

represents the key matrix, S represents a codebook, and T in the upper corner of a matrix indicates the mathematical operation of transpose of the matrix. Conventional attention mechanism is employed by large language models (LLMs) and have shown unparalleled success in understanding the underlying characteristics of natural language. Single-channel data can be treated equivalently to sentences, by dividing the signal into 1D patches, which form the tokens. This modality has attracted considerable interest frequently for speech recognition tasks that are related to the natural language domain. However, there are several drawbacks in applying the conventional attention mechanism to multi-dimensional inputs (e.g., image data or multi-channel time series data). For example, flattening patches of multi-dimensional inputs into 1D sequences leads to a loss of spatial structure as nearby patches in space are no longer necessarily close in the sequence. Thus, any information about the structure of the patches is lost. When the size of the images, the number of patches, and the flattening direction are kept constant, a conventional transformer-based model using the conventional attention mechanism might autonomously learn it. When the transformer-based model learns the structure, it cannot be exposed to different images as it would completely misinterpret them. When the transformer-based model does not learn the structure, it is missing critical information. This leads to an inflexible model which cannot easily generalize to different inputs. Another drawback is the conventional transformer-based model does not distinguish between the two dimensions of height and width (e.g., it does not distinguish between up, down, left, and right). As such, the conventional transformer-based model utilizing conventional attention mechanism is unsuitable for classifying and/or predicting multi-variate time series data as the two dimensions of time and channels require delicate handling.

EEG signals are multi-variate recordings of the brain. Transformer-based approaches to EEG are sparse due to the complexity of the data. In iEEG recordings, a subject may be implanted with electrodes directly in multiple areas of the brain for the purpose of clinical diagnosis. There is no standardized location, or even number of electrodes, for intracranial implants. This makes iEEG an extremely heterogeneous data modality, intractable for conventional attention approaches. The channels present a fundamental source of information, as electric fields spread in different areas of the brain on different time-scales and with different intensities depending on the strength of the connection between the areas. Moreover, the relationship between brain regions is not always proportional to their spatial closeness, as distant areas might be more strongly connected than close ones. There is a tremendously intricate interplay between space and time that may be learned by the self-attention mechanism 700A, which is configured to handle any possible electrode configuration and clinical setup, and to extract as much information as possible from all aspects of the data.

While the conventional attention mechanism utilizes one codebook, the self-attention mechanism 700A is implemented via two separate learnable positional codebooks, including a first positional codebook representing space ( [symbol] ) and a second positional codebook representing time ( [symbol] ). A dual encoding may be established to enable individual evaluation of the time dimension and the space dimension. Further, self-attention mechanism 700A is configured to evaluate the interplay between the time dimension and the space dimension to determine the relationship between time and space at the attention level. This is an improvement over the conventional attention mechanism because self-attention mechanism 700A allows a multi-variate parallel attention model (e.g., transformer-based model) to efficiently model a time-series at a lower level.

For example, self-attention mechanism 700A may determine an attention value A using

$${A}_{i , j} = {( {X}_{a\_i , b\_i} + {T}_{a\_i} + {C}_{b\_i} )}^{T} {W}_{q}^{T} {W}_{k}^{T} ( {X}_{a\_j , b\_j} + {T}_{a\_j} + {C}_{b\_j} ) , \qquad Equation 2$$

wherein A_{i,j} represents an attention value at index i and j, X represents an input (e.g., embeddings of time series data 705),

$${W}_{q}^{T}$$

represents a query matrix,

$${W}_{k}^{T}$$

represents a key matrix, C_{b_i} and C_{b_j} are first positional codebook representing space, T_{a_i} and T_{a_j} are second positional codebook representing time, a and b represent indices, and T in the upper corner of a matrix indicates the mathematical operation of transpose of the matrix.

To remove higher-order cross-correlations (e.g., second-order correlations between time and space) resulting from processing based on Equation 2, the cross-correlations may be squashed by pushing as much of the spatio-temporal computation as possible to the lower levels of processing without overwhelming it. This provides an improvement over conventional techniques because conventional transformer models using a conventional attention mechanism requires ancillary structures to process any relation between time and space, thus requiring additional computational resources. Relative distances in the time and space dimensions between segments of time series data 705 may be encoded. Learnable bias terms u, v, w may be used to reduce the number of operations. Thus, Equation 2 may be expanded to remove cross-terms representing the cross-correlations between dimensions, resulting in

$${A}_{i} , j = {X}_{i}^{T} {W}_{q}^{T} {W}_{k\_S} {X}_{j} + {u}^{T} {W}_{k\_S} {X}_{j} + {X}_{i}^{T} {W}_{q}^{T} {W}_{k\_T} {T}_{i - j} + {v}^{T} {W}_{k\_T} {T}_{i - j} + {X}_{i}^{T} {W}_{q}^{T} {W}_{k\_C} {C}_{i - j} + {w}^{T} {W}_{k\_C} {C}_{i - j} . \qquad Equation 3$$

Equation 3 may be divided into three components, each representing a specific attention. For example, content based-attention may be represented by

$${X}_{i}^{T} {W}_{q}^{T} {W}_{k\_S} {X}_{j} + {u}^{T} {W}_{k\_S} {X}_{j} ,$$

which is quadratic in the number of inputs (e.g., O(T²C²), where O stands for complexity, T stands for time and C for channel/space). Time-based attention may be represented as

$${X}_{i}^{T} {W}_{q}^{T} {W}_{k\_T} {T}_{i - j} + {v}^{T} {W}_{k\_T} {T}_{i - j} ,$$

which is subquadratic in the number of inputs (e.g., O(T²C)). Channel-based attention may be represented as

$${X}_{i}^{T} {W}_{q}^{T} {W}_{k\_C} {C}_{i - j} + {w}^{T} {W}_{k\_C} {C}_{i - j} ,$$

which is subquadratic in the number of inputs (e.g., O(TC²)). The conventional attention mechanism is fully quadratic, which represents a significant computational roadblock because the input becomes intractable as the number of channels increases, especially for multi-variate time series. At the same time, more channels imply more sources of information, which cannot be disregarded. In contrast, the time-based and channel-based attention components described herein are subquadratic, thus providing improved computational complexity resulting in more efficient use of computational resources and higher performance (e.g., 3.5 times speedup in processing time).

For example, Letting T be the number of time segments and C be the number of channels, the context length of a conventional transformer-based model becomes T×C and number of terms necessary to compute for conventional attention is O(T²×C²). Given a reasonable estimation of 100 segments and 50 channels the context length would be 5000, which may present intractability issues even for language models. It should be understood that it is not necessary to compute a full square matrix, which would be quadratic in the context length (i.e. both time and space). All elements of the time-based attention are the same for each channel, and all elements of the channel-based attention are the same for each time point. Thus, complexity is quadratic in one dimension and constant in the other. The elements along a specified dimension may be repeated at no additional cost. Then, a shifting operation may be employed to compute all relative embeddings in one pass.

The shifting operation is configured to compute the time-based and channel-based attention components. For example, in a time shifting operation, let

$${q}_{t} = {x}_{\cdot t}^{T} {W}_{q}^{T} , {p}_{c} = {x}_{c \cdot }^{T} {W}_{q}^{T} , {T}_{i} = {W}_{{k}_{t} {𝒯}_{𝒯 - 1 - 𝒾}} , and {C}_{i} = {c - 1 - 𝒾}_{} .$$

The time shifting operation may be performed as follows:

$$( \begin{matrix}{q}_{0} {T}_{0} & {q}_{0} {T}_{1} & ⋯ & ⋯ & {q}_{0} {T}_{T - 1} \\ {q}_{1} {T}_{0} & {q}_{1} {T}_{1} & ⋯ & ⋯ & {q}_{1} {T}_{T - 1} \\ ⋮ & ⋮ & ⋮ & ⋮ & ⋮ \\ {q}_{T - 1} {T}_{0} & {q}_{T - 1} {T}_{1} & ⋯ & ⋯ & {q}_{T - 1} {T}_{T - 1}\end{matrix} ) \text{} \text{} {ShiftTime}_{\to } ( \begin{matrix}{q}_{0} {T}_{T - 1} & 0 & ⋯ & ⋯ & 0 \\ {q}_{1} {T}_{T - 2} & {q}_{1} {T}_{T - 1} & 0 & ⋯ & 0 \\ ⋮ & ⋮ & ⋮ & ⋮ & ⋮ \\ {q}_{T - 1} {T}_{0} & ⋯ & ⋯ & ⋯ & {q}_{T} {T}_{T - 1}\end{matrix} ) .$$

In the time shifting operation, qₜ is a product between a value xₜ and the query matrix W_{q}, and p_{c} is a product between a value xₑ and the query matrix W_{q}. The right triangular matrix is zeroed out as a requisite of autoregressive training, i.e., one cannot attend to keys in the future. The entire time shifting operation can be performed efficiently and quickly using tensor manipulation.

The channel shifting operation may be performed as follows:

$$( \begin{matrix}{p}_{0} {C}_{0} & {p}_{0} {C}_{1} & ⋯ & ⋯ & {p}_{0} {C}_{C - 1} \\ {p}_{1} {C}_{0} & {p}_{1} {C}_{1} & ⋯ & ⋯ & {p}_{1} {C}_{C - 1} \\ ⋮ & ⋮ & ⋮ & ⋮ & ⋮ \\ {p}_{C - 1} {C}_{0} & {p}_{C - 1} {C}_{1} & ⋯ & ⋯ & {p}_{C - 1} {C}_{C - 1}\end{matrix} ) \text{} \text{} {ShiftChannel}_{\to } ( \begin{matrix}{p}_{0} {C}_{C - 1} & {p}_{0} {C}_{C - 2} & ⋯ & ⋯ & {p}_{0} {C}_{0} \\ {p}_{1} {C}_{C - 2} & {p}_{1} {C}_{C - 1} & {p}_{1} {C}_{C - 2} & ⋯ & {p}_{1} {C}_{1} \\ ⋮ & ⋮ & ⋮ & ⋮ & ⋮ \\ {p}_{C - 1} {C}_{0} & ⋯ & ⋯ & ⋯ & {p}_{C} {C}_{C - 1}\end{matrix} ) .$$

In the channel shifting operation, no element is zeroed out, as all channels can attend to all other channels. In certain embodiments, the time shifting operation and channel shifting operation may be implemented using tensor manipulation via a machine learning library including a plurality of modules configured to perform tensor computations. For example, the time shifting operation and channel shifting operation may be implemented via PyTorch® or Triton. PyTorch is a registered trademark of the Linux Foundation. Triton is an open-source programming language.

To further reduce computational cost associated with computing the content-based attention with little impact to performance, a local attention window may be determined. The local attention window focuses on the most recent L time points, discarding ones which have little information content. Since time-based attention is not limited, the lookup window still spans the entire context. Thus, for L<<T, the total complexity of self-attention mechanism 700A is O(T²×C+T×C²), quadratic in each dimension but subquadratic in the context length. In certain embodiments, self-attention mechanism 700A pushes the effective total context length to over 10,000.

In certain embodiments, content-based attention may only attend to the content of query and key without any positional encoding, time-based attention may only attend to the query and the distance in time with the key, and channel-based attention may only attend to the query and the distance in space with the key. Each attention component may be equipped with its own key matrix Wₖ_{ₑ}, Wₖ_{ₜ}, Wₖ_{_{c}}, to further increase semantic distance. The positional codebooks C and T may track the relative distance to allow inputs (e.g., signals) with arbitrary length in any of the dimensions. In an exemplary embodiment where the inputs are time series data representing signals collected by electrodes in a clinical environment, an absolute position (e.g., in the channel dimension) of a segment in the time series data provides little to no information due to the heterogeneity of clinical setups. Thus, a relative encoding scheme allows the channel-based attention component to uncover hidden connection map between the electrodes. Given the three attention components (e.g., time, channel, and content) are independent of each other, any one of the attention components may be excluded to further reduce computation. Further, as an additional cost-saving measure, grouped query attention may be used to reduce the number of heads without loss of performance. Overall, relative encoding may be leveraged to allow arbitrary expansion of signal in all dimensions without loss of performance.

Pseudocode 700B providing an example manner for implementing a multi-variate parallel attention model (e.g., via multi-channel analysis code 200, computer 101, etc.) according to an embodiment of the present invention is illustrated in FIG. 7B. The algorithm of pseudocode 700B may take as input a plurality of output tokens generated via an encoder, each output token x_{c,t} is represented as an embedding in a plurality of embeddings (e.g., n_{embed}=768). Each output token x_{c,t} is associated with a channel encoding c and a time encoding t. The algorithm of pseudocode 700B may include a plurality of attention heads (e.g., the total number of heads represented by a parameter n_{head}), each attention head h is associated with a query q. The algorithm of pseudocode 700B may include a plurality of grouped query attention (GQA) heads (e.g., the total number of GQA heads represented by a parameter n_{gqa}), each GQA head h_{k,v} is associated with a key k and a value v. The algorithm of pseudocode 700B may also include biases u, y, and w.

In the algorithm of pseudocode 700B, a GQA mechanism may be used. The GQA mechanism is configured to separate computation of queries from computation of keys and values. That is, for example, output token x_{ct} is processed by a first linear operation with no bias to generate a query

$${q}_{ct}^{h} .$$

Further, output token x_{ct} is processed by a second linear operation with no bias to generate a key

$${k}_{ct}^{{h}_{k , v}}$$

and a value

$${v}_{ct}^{{h}_{k , v}} .$$

Then, a multi-variate parallel attention including a time-based attention, a channel-based attention, and a content-based attention is determined. The content-based attention

$${g}_{ct , {c}^{′} t ′}^{h}$$

is computed based on

$${( {q}_{ct}^{h} + {u}^{{h}_{kv}} )}^{T} {q}_{c ′ t ′}^{h} ,$$

wherein bias u is associated with GQA head h_{k,v}. Since the time-based attention

$${s}_{t}^{h}$$

and the channel-based attention

$${l}_{c}^{h}$$

are independent of the key content, the time-based attention and the channel-based attention do not need to recomputed. The time-based attention

$${s}_{t}^{h}$$

is computed based on

$${( {q}_{ct}^{h} + {y}^{{h}_{k v}} )}^{T} {t}^{{h}_{k v}} ,$$

wherein bias y is associated with GQA head h_{k,v}. The channel based attention

$${l}_{c}^{h}$$

is computed based on

$${( {q}_{ct}^{h} + {w}^{{h}_{k v}} )}^{T} {c}^{{h}_{k v}} ,$$

wherein bias w is associated with GQA head h_{k,v}. Further, Tin the upper corner of a matrix indicates the mathematical operation of transpose of the matrix.

The time-based attention and channel-based attention may be shifted to avoid recomputation (e.g., via a Transformer-XL model). For example, a time-shifting operation may be performed on the time-based attention

$${s}_{t}^{h} to generate {s}_{tt ′}^{h} .$$

A channel-shifting operation may be performed on the channel-based attention

$${l}_{c}^{h} to generate {l}_{cc ′}^{h} .$$

Then, a causal mask may be applied to the sum of the three attention components. For example, a causal mask may be applied to

$$( {g}_{ct , {c}^{′} t ′}^{h} + {s}_{tt ′}^{h} + {l}_{cc ′}^{h} )$$

to generate an output

$${m}_{ct , {c}^{′} t ′}^{h} . The output {m}_{ct , {c}^{′} t ′}^{h}$$

is further processed with a window mask operation to generate an output

$${n}_{ct , {c}^{′} t ′}^{h} .$$

A structured dropout operation may be performed on the output

$${n}_{ct , {c}^{′} t ′}^{h}$$

to generate an output

$${d}_{ct , {c}^{′} t ′}^{h} . The output {d}_{ct , {c}^{′} t ′}^{h}$$

and the parameter n_{embed} may be provided as input to a sigmoid function to generate a final attention value

$${a}_{ct , {c}^{′} t ′}^{h} .$$

An output attention

$${o}_{ct}^{h}$$

is generated based on

$${Σ}_{{c}^{′} ,} {a}_{ct , {c}^{′} {t}^{′}}^{h} \cdot {v}_{ct , {c}^{′} {t}^{′}}^{h}$$

and returned as the result of the algorithm of pseudocode 700B.

A comparison 700C of a structured dropout operation 752 with a conventional dropout operation 755 (e.g., via multi-channel analysis code 200, computer 101, etc.) according to an embodiment of the present invention is illustrated in FIG. 7C. Dropout is a common technique to improve the generalization performance of neural networks. In transformer-based models, dropout is often applied inside an attention block to randomly zero-out some query-key attentions to avoid over-reliance of the model on specific connections. Dropout usually applies to all elements with equal probability and creates uniform holes in the attention matrix. This is not efficient in the case of multi-variate time series, as for each hole the neighboring segments are likely to carry very similar information, reducing effectiveness of conventional dropout. For example, conventional dropout operation 755 is configured to blank segments randomly, which is less effective with time series data because adjacent segments in time or space contain much of the same information. To address these issues, the structured dropout operation 752 is configured to drop entire channels and/or entire time steps to reduce the number of correlated segments. The dropout rate may be computed to maintain the same number of dropped out segments as a conventional dropout operation 755.

The structured dropout operation 752 may include a channel-specific dropout rate c_{drop} and a time-specific dropout rate t_{drop}. The computation of c_{drop} and t_{drop} may be based on a dropout rate r_{drop} associated with conventional dropout operation 755 as follows: t_{drop}=c_{drop}=1−\sqrt{1−r_{drop}}. This computation ensures that approximately the same overall number of elements are zeroed. The r_{drop} value may be configured by the user.

Pseudocode 700D providing an example manner for implementing a flash multi-variate parallel attention model (FlashMVPA) (e.g., via multi-channel analysis code 200, computer 101, etc.) according to an embodiment of the present invention is illustrated in FIG. 7D. The algorithm of pseudocode 700D may take as input a plurality of output tokens generated via an encoder, each output token x_{ct} is represented as an embedding in a plurality of embeddings (e.g., n_{embed}=768). Each output token x_{ct} is associated with a channel encoding c and a time encoding t. The algorithm of pseudocode 700D may include a plurality of attention heads (e.g., the total number of heads represented by a parameter n_{head}), each attention head h is associated with a query q. The algorithm of pseudocode 700D may include a plurality of GQA heads (e.g., the total number of GQA heads represented by a parameter n_{gqa}), each GQA head h_{k,v} is associated with a key k and a value v. The algorithm of pseudocode 700D may also include biases u, y, and w.

In the algorithm of pseudocode 700D, a GQA mechanism may be used. The GQA mechanism is configured to separate computation of queries from computation of keys and values. That is, for example, output token x_{ct} is processed by a first linear operation with no bias to generate a query

$${q}_{ct}^{h} .$$

Further, output token x_{ct} is processed by a second linear operation with no bias to generate a key

$${k}_{ct}^{{h}_{k , v}}$$

and a value

$${v}_{ct}^{{h}_{k , v}} .$$

The time-based attention

$${s}_{t}^{h}$$

is computed based on

$${( {q}_{ct}^{h} + {v}^{{h}_{k v}} )}^{T} {t}^{{h}_{k v}} .$$

The channel-based attention

$${l}_{c}^{h}$$

is computed based on

$${( {q}_{ct}^{h} + {w}^{{h}_{k v}} )}^{T} {c}^{{h}_{k v}} ,$$

wherein bias w is associated with GQA head h_{k,v}. Further, T in the upper corner of a matrix indicates the mathematical operation of transpose of the matrix. Then, a multi-variate parallel attention (MVPA) (e.g., implemented in Triton) may take as inputs the query

$${q}_{ct}^{h} ,$$

the time-based attention

$${s}_{c}^{h} ,$$

the channel-based attention

$${l}_{c}^{h} ,$$

the value v, and the biases u, y, and w and combine these inputs into one kernel. Based on the inputs, the MVPA generates an output attention

$${o}_{ct}^{h} .$$

The algorithm of pseudocode 700D for implementing a flash multi-variate parallel attention model may be leveraged to achieve efficient video random-access memory (VRAM) consumption when performing classification and/or prediction tasks. The training effectiveness of a multi-variate parallel attention model may be heavily affected by batch size since its training process draws negative samples from the batch. The bigger the batch size, the more variety in the negative samples and the better the model generalizes. In an exemplary embodiment, given a large context size of the multi-variate parallel attention model (e.g., context size up to 10 k), an implementation of scaled dot product attention may consume a significant amount of VRAM. Thus, the algorithm of pseudocode 700D may be leveraged to make VRAM consumption linear instead of quadratic in the context length, enabling training on much longer context. For example, the algorithm of pseudocode 700D may be implemented via an open-source programming language (e.g., the Triton language) that gives lower-level access to parallel computing platform primitives, such as Compute Unified Device Architecture (CUDA®) primitives. CUDA is a registered trademark of Nvidia Corporation. In certain embodiments, the time-based attention and the channel-based attention are computed via matrix-multiply operations in PyTorch, and outputs of these computations are shifted and added via Triton. The content-based component may be fully implemented in Triton.

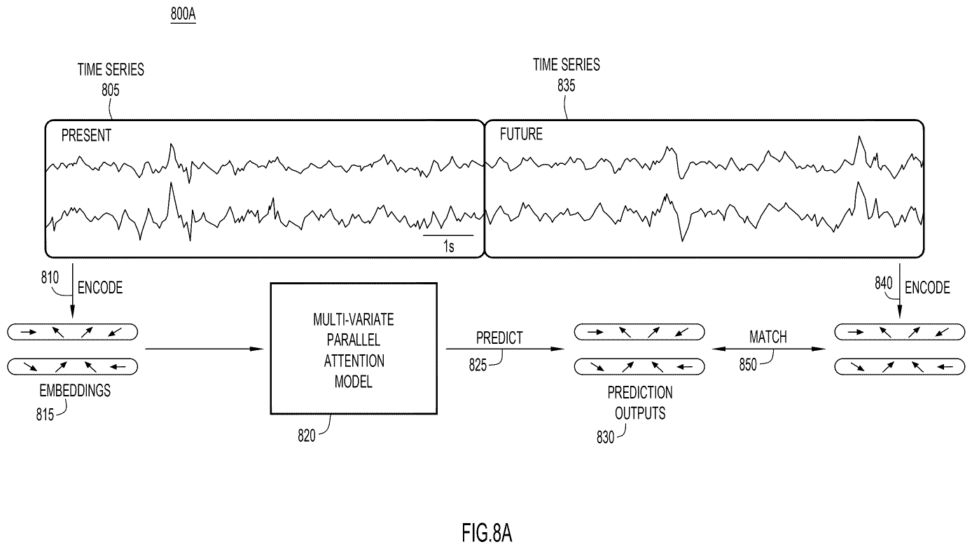

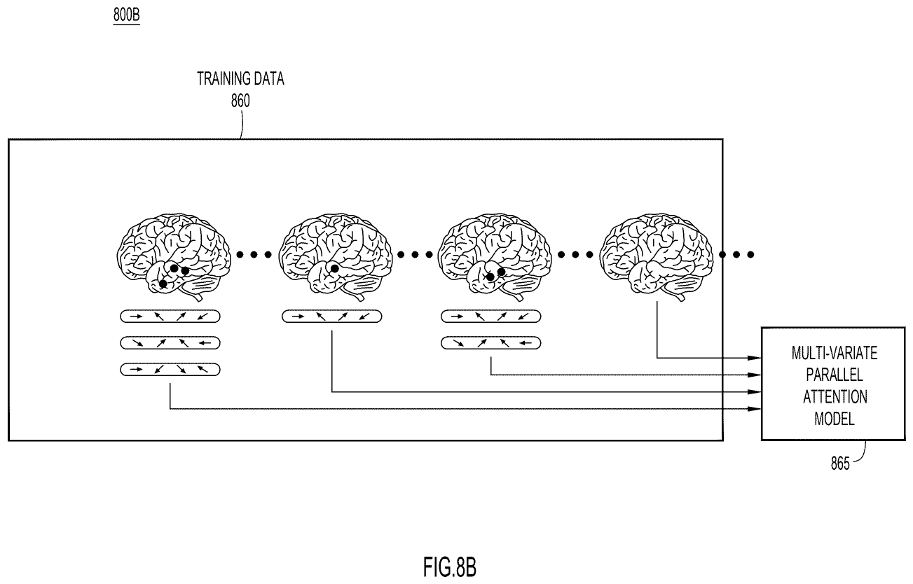

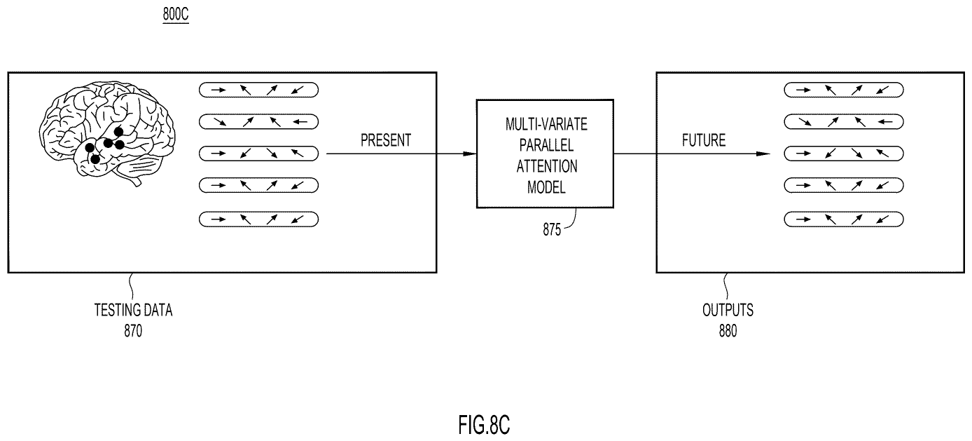

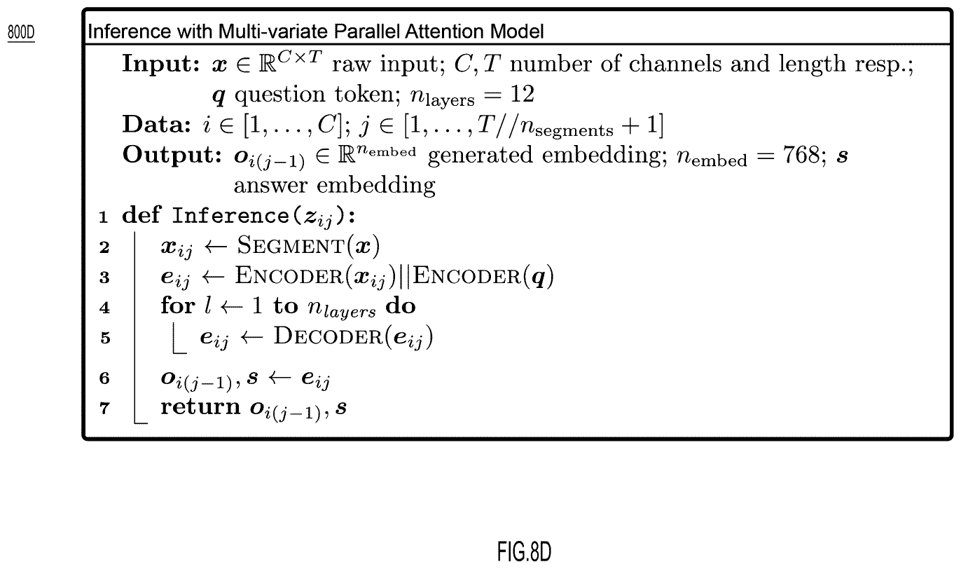

A method 800A configured to perform a prediction task via a multi-variate parallel attention model (e.g., via multi-channel analysis code 200, computer 101, etc.) according to an embodiment of the present invention is illustrated in FIG. 8A. Initially, a time series 805 may be processed at an encode operation 810 (e.g., via encoder 500A) to generate a plurality of embeddings 815. The time series 805 may be a multi-channel time-series having a plurality of variables (e.g., multi-variate time series). For example, time series 805 may be an iEEG signals dataset collected at a clinical setting. The iEEG signals dataset may include recordings of neuronal activity of subjects indicating both ictal and non-ictal events. Each of the windows is divided into segments, which are processed to generate a plurality of tokens that may be encoded into the plurality of embeddings 815.

The plurality of embeddings 815 is provided as input to a multi-variate parallel attention model 820. As described above, the multi-variate parallel attention model 820 may be configured to determine a time-based attention, a channel-based attention, and a content-based attention in parallel in parallel via a multi-variate parallel attention mechanism. Then, the multi-variate parallel attention model 820 is configured to perform a prediction task at a predict operation 825. For example, multi-variate parallel attention model 820 is configured to generate a plurality of prediction outputs 830 including a plurality of predicted future time series data that correspond to time series 805. In certain embodiments, the multi-variate parallel attention model 820 may generate upcoming neuronal activity based on recorded neuronal activity represented in time series 805.

A time series 835 may be a multi-channel time-series having a plurality of variables (e.g., multi-variate time series). The time series 835 includes a plurality of observed time series data that follow the time series 805. For example, the time series 805 may include recordings of neuronal activity from time 0 to time T, and the time series 835 may include recordings of neuronal activity from time T+1 to another time in the future. The time series 835 may be processed at an encode operation 840 (e.g., via an encoder) to generate a plurality of embeddings that may be matched against the plurality of prediction outputs 830 at a match operation 850. That is, the plurality of embeddings corresponding to the time series 835 (e.g., actual neuronal activity at time T+1) is compared the plurality of prediction outputs 830 (e.g., neuronal activity of time T+1 as predicted by multi-variate parallel attention model 820). The comparison may generate a loss, which may be optimized to train the multi-variate parallel attention model 820.

A method 800B configured to train a multi-variate parallel attention model (e.g., via multi-channel analysis code 200, computer 101, etc.) according to an embodiment of the present invention is illustrated in FIG. 8B. Initially, a plurality of training data 860 is provided to train a multi-variate parallel attention model 865. For example, the plurality of training data 860 may include iEEG signals dataset collected at a clinical setting. The iEEG signals dataset may include recordings of neuronal activity of subjects indicating both ictal and non-ictal events. In certain embodiments, a slide window approach may be used such that each of the recordings is divided into overlapping windows of a specific number of seconds (e.g., 500 seconds), with an overlap of a specified percentage (e.g., 99%) to increase the size of a training dataset and the number of training tokens. A different stride to ictal and non-ictal events may be applied to balance the dataset. The ratio between non-ictal and ictal events may be configured to obtain a balanced dataset (e.g., a ratio of 100:1 leading to 1% of the data represents seizures). Each of the windows is divided into segments, which are processed to generate a plurality of tokens that may be encoded into the plurality of embeddings. The plurality of embeddings is provided as input to train the multi-variate parallel attention model 865 to perform a classification task (e.g., detect an ictal event) and/or a prediction task (e.g., generate neuronal activity).

In certain embodiments, the training of the multi-variate parallel attention model 865 may be implemented in an end-to-end manner. In the end-to-end training, B windows are selected at random from the plurality of training data 860 to form a batch. Each window W_{i∈[1 . . . B]} has an arbitrary sample rate and Cᵢ channels. The sampling rate may be normalized to a specified frequency (e.g., 512 Hz), then the windows are divided into S non-overlapping segments per-channel, resulting in Cᵢ×S segments per window. Each segment is passed in parallel through an encoder. For example, suppose one window W* is selected at random as the positive window, and all the others as the confounding windows. The embeddings of W* form the input context E. In E, all the embeddings corresponding to the last time step are removed, such that the context length is

$${\overbrace{{C}^{*} \times ( s - 1 )}}^{Signal embeddings minus last} .$$

For each of the segments, k embeddings are selected at random from the confounding windows to form the negative samples N. Each N_{c,t} has k elements, thus N has size C*×(s−1)×k. N is excluded from backpropagation. The multi-variate parallel attention model 865 may process the entire E at once and produce an output O also of size C*×(s−1). Then, losses are computed to iteratively optimize to train the model.

For example, the multi-variate parallel attention model 865 may be trained using a contrastive loss and an auxiliary loss. To compute the contrastive loss, having other windows in a batch is important because a larger batch size leads in general to a more stable training and better generalization performance. For example, let eⁱ, i∈[1, . . . , B] be the outputs of a signal Encoder and dⁱ, i∈[1, . . . , B] the outputs of a Decoder stack, for B the batch size. For each i*, n_{negatives} elements from eⁱ, i≠i* are randomly selected as negative samples nⁱ*. The size of the batch may affect the entropy (e.g., the bigger the batch the greater the entropy). The contrastive loss [symbol] for each i* as follows:

$${ℒ}_{ct} = - log \frac{exp ( si m ( {d}_{ct} , {e}_{c ( t + 1 )} ) / τ )}{{Σ}_{n ∈ {n}_{n e g a t v e s}} exp ( s i m ( {d}_{ct} , n ) / τ )} .$$

Summing over every i, channel c, time t provides the optimization target for a generative task (e.g., predicting neuronal activity). The loss is invariant to the channel c, which encourages all the outputs to be the same regardless of channel. The temperature T may be configurable (e.g., τ=0.1).

To train the multi-variate parallel attention model 865 for a classification task, a classification head may be attached to multi-variate parallel attention model 865. The classification loss may be a binary cross-entropy loss. The combination of multi-variate parallel attention model 865 and the classification head may be trained using Low-Rank Adaptation of Large Language Models (LoRA). For example, a small classification head may be created for each new task and dataset to improve the performance of multi-variate parallel attention model 865 on the task at hand. The classification head is composed of a single linear layer to keep computational overhead low. This layer has input size equal to the Decoder's block output size, and output size equal to the dimensionality of the classification task (e.g., a dimensionality of 2 for a seizure classification task). The input Hᵢₙ to the classification head is a mean-pooled output of the last time series (e.g., signal) segment in time. For example,

$${H}_{i n} = \frac{1}{c} {Σ}_{c} {d}_{c ( S - 1 )} .$$

S represents a signal segment, and S−1 represents the last signal segment in time. The output of the classification head is then passed through a softmax function to compute the binary cross-entropy loss. In an exemplary implementation via PyTorch, the output step and the softmax operation may be merged to achieve computational improvements. For example, the multi-variate parallel attention model 865 may be fine-tuned using LoRA on the query (q) and value (v) layers with a specified rank value (e.g., 8) and a specified alpha value (e.g., 16). The full classification head may be fine-tuned, thus producing a number of trainable parameters during fine-tuning of a small portion (e.g., approximately 0.1%) of the model.

In certain embodiments, the multi-variate parallel attention model 865 may be trained on a single node with a plurality of graphics processing unit (GPU) for a predetermined period of time (e.g., two weeks). An optimizer with a specified weight decay (e.g., FusedAdam with 0.1 weight decay) may be chosen to train the multi-variate parallel attention model 865. A training strategy may be selected from a deep learning optimization library. The training strategy may be without activation checkpointing and the learning rate may be fixed to a specified value (e.g., 10-4). For example, the multi-variate parallel attention model 865 may process 4.6 hours of data per second per GPU, compared to 1.2 hours per second per GPU by a conventional attention model.

In an example embodiment, the multi-variate parallel attention model 865 may be trained to predict the next brain state using a dataset of intracranial EEG signals from patients suffering from epilepsy. The multi-variate parallel attention model 865 may be trained on large quantities of data (e.g., 39 billion segments across the entire dataset with 390 million of unique segments) for a configurable length of time (e.g., 5000 hours). The multi-variate parallel attention model 865 may perform tasks with fine-tuning or via a zero-shot manner (e.g., without fine-tuning). The multi-variate parallel attention model 865 can reliably predict brain states during a seizure with a next state prediction accuracy of greater than 99% out of a set of 30 output possibilities. In addition to or concurrent with next brain state prediction, the multi-variate parallel attention model 865 may be trained to predict seizure occurrence and/or perform any types of classification associated with the input iEEG data, such as sleep scoring, stroke detection, etc. Performance of the multi-variate parallel attention model 865 is superior to that of models that are fine-tuned on a specific patient in the input data.

A method 800C configured to perform a prediction task via a multi-variate parallel attention model based on testing data (e.g., via multi-channel analysis code 200, computer 101, etc.) according to an embodiment of the present invention is illustrated in FIG. 8C. Initially, a plurality of testing data 870 is provided to test a multi-variate parallel attention model 865. For example, the plurality of testing data 870 may include iEEG signals dataset collected at a clinical setting. The plurality of testing data 870 may be processed via an encoder to generate a plurality of embeddings. The multi-variate parallel attention model 875 may be a model trained via a training procedure (e.g., method 800B). Based on the plurality of embeddings associated with the plurality of testing data 870, the multi-variate parallel attention model 875 is configured to generate a plurality of outputs 880 (e.g., prediction outputs). The plurality of outputs 880 may be in the form of embeddings. For example, the multi-variate parallel attention model 875 may predict upcoming neuronal activities.

The generation of prediction outputs (e.g., brain signals representing neuronal activity) by multi-variate parallel attention model 875 may proceed analogously as during the training of the model. Then, a cosine similarity is measured directly in a three-way reference scheme. First, the cosine similarity of the output with the true target is determined. Second, the similarity of the output with the maximally correlated target is determined. Third, the cosine similarity, with the highest form of entropy available, is determined with random segments in the batch that are still close by in time. The cosine similarity measured via the three-way reference scheme ensures that the difference in similarity between the true and confounding targets remains significant.

In certain embodiments, the plurality of outputs 880 (e.g., brain signals representing neuronal activity/event) may be further processed via post-processing operations. For example, the post-processing operations include merging events within minutes and/or seconds (e.g., 5 minutes) of each other, removing events shorter than a specified length of time (e.g., 20 seconds in length), and/or removing events with less than a specified number of positive responses (e.g., 5 positive responses). Further, multiple seizures detected in one minute are merged into one event. Further, a thresholding mechanism may be implemented to decide whether to report a seizure or not. For example, a threshold of 3 positive seconds out of 10 is set as the lower limit for detecting a seizure to deter false positives. Events shorter than 3 seconds are not reported, and an additional latency of 3 seconds may be considered. The threshold may be configured based on user requirements.

The performance of multi-variate parallel attention model 875 on a classification and/or prediction task may be assessed based on a plurality of metrics. For example, for a seizure detection task, multi-variate parallel attention model 875 may be evaluated based on a kappa score (also known as Cohen's kappa coefficient), which measures inter-rater agreement in classification outputs generated by multiple raters (e.g., between the model and an expert). The kappa score ranges from 0 (no agreement) to 1 (complete agreement). In the case of seizure detection, there might be broad disagreement among experts (e.g., neurologists) over atypical seizures, and at the same time no disagreement at all over typical seizures. This phenomenon makes accurate classification difficult and contributes to the varied spread of performance between the model and the human expert. To better assess the impact of this latent classification difficulty, a multiple correlation analysis may be performed using three variables, including the total recording length, the number of seizures, and the frequency of seizures, to predict the kappa score. In certain embodiments, multi-variate parallel attention model 875 may yield a coefficient of determination (R²) of 0.054. The model performance is thus independent of the three variables, and the latent classification difficulty might help explain most of the variance. Compared to conventional transformer-based models, multi-variate parallel attention model 875 has notably higher (e.g., 1.9 time higher) kappa score, indicating that the classification and/or prediction outputs from multi-variate parallel attention model 875 align closely with expert classification. Further, performance metrics of multi-variate parallel attention model 875 that may be reported include F-1 score, sensitivity, false positive rates, etc. Compared to conventional transformer-based models, multi-variate parallel attention model 875 has improved performance metrics, including lower false positive rates. Moreover, in certain embodiments, the average kappa score of multi-variate parallel attention model 875 is increased to 0.48, which is within the range of human expert performance.

Pseudocode 800D providing an example manner for performing an inference task via a multi-variate parallel attention model (e.g., via multi-channel analysis code 200, computer 101, etc.) according to an embodiment of the present invention is illustrated in FIG. 8D. Inputs to the algorithm of pseudocode 800D may include a plurality of raw inputs x (e.g., a time series having n_{segments} segments), wherein each segment x_{i,j} of the plurality of raw inputs (e.g., a time series segment) is associated with a channel in a number of C channels and a specific time in a length of time T. An index i may be associated with a channel in the C channels, and an index j may be associated with a specific time in the time T. The inputs to the algorithm of pseudocode 800D further include a question token q and a number of layers n_{layers}. The n_{layers} parameter may be configured by the user.

In the algorithm of pseudocode 800D, the plurality of raw inputs x is segmented into a plurality of segments xᵢⱼ through a segmentation operation. Each segment x_{i,j} is processed by an encoder. Separately, the question token q is also processed by the encoder. The encoder, based on the segment xᵢⱼ and the question token q, generates an embedding eᵢⱼ. The algorithm of pseudocode 800D proceeds iteratively from a layer l=1 to layer l=n_{layers} to decode the embedding eᵢⱼ via a decoder. The decoded embedding eᵢⱼ is set as an answer embedding s. The generated embedding oᵢ₍ⱼ₋₁₎ and the answer embedding s are returned as the results of the algorithm of pseudocode 800D.

Present invention embodiments provide various technical and other advantages. For example, the present invention embodiments leverage a transformer with a multi-variate parallel attention model to generate prediction and/or classification of multi-channel input data. The multi-variate parallel attention model is configured to determine a time-based attention, a channel-based attention, and a content-based attention in parallel, thus reducing computational complexity associated with transformer-based analysis of multi-variate time series. The multi-variate parallel attention mechanism alleviates intractability issues and overcomes computational roadblocks associated with processing heterogeneous data of varying length and dimension, thus resulting in more efficient use of computational resources and higher computational performance. Further, present invention embodiments provide a multi-variate parallel attention model that can effectively capture contextual information by simultaneously attending to time, channel, and content of input data, thus enabling enhanced performance of classification and/or prediction tasks.

It will be appreciated that the embodiments described above and illustrated in the drawings represent only a few of the many ways of implementing embodiments for multi-channel time series analysis via a transformer with a multi-variate parallel attention model.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., multi-channel analysis code 200) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., prediction and/or classification outputs, model parameters, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., prediction and/or classification outputs, model parameters, etc.).

The present invention embodiments are not limited to the specific tasks or algorithms described above, but may be utilized for generating prediction and/or classification outputs of data of any quantity of dimensions or channels from any data source.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of performing a prediction task or a classification task comprising:
generating, via at least one processor, a plurality of tokens from a plurality of multi-channel inputs;
generating, via an encoder of the at least one processor, a plurality of embeddings from the plurality of tokens; and
performing, via a multi-variate parallel attention model of the at least one processor, the prediction task or the classification task based on the plurality of embeddings, wherein the multi-variate parallel attention model is configured to determine a time-based attention, a channel-based attention, and a content-based attention in parallel.

2. The method of claim 1, wherein the plurality of multi-channel inputs includes multi-channel time series data, and wherein generating the plurality of tokens comprises:
dividing the plurality of multi-channel inputs into a plurality of temporal windows each including a subset of the plurality of multi-channel inputs associated with a time;
dividing each of the plurality of temporal windows into a plurality of segments each associated with a channel represented in the plurality of multi-channel inputs; and
processing, via a feature extraction technique, the plurality of segments to generate the plurality of tokens.

3. The method of claim 1, further comprising:
training, via the at least one processor, the multi-variate parallel attention model to simultaneously perform the prediction task and the classification task, wherein the prediction task includes predicting one or more data points following the plurality of multi-channel inputs and the classification task includes classifying a category associated with the plurality of multi-channel inputs.

4. The method of claim 3, wherein training the multi-variate parallel attention model comprises:
summing the time-based attention, the channel-based attention, and the content-based attention to determine an attention value to train the multi-variate parallel attention model.

5. The method of claim 1, wherein the multi-variate parallel attention model includes a decoder and a multi-layer perceptron.

6. The method of claim 2, wherein the time-based attention is determined based on temporal distances between each of the plurality of segments and other segments of the plurality of segments, wherein the channel-based attention is determined based on spatial distances between each of the plurality of segments and the other segments, wherein the content-based attention is determined by applying a self-attention mechanism to the plurality of segments, wherein the temporal distances are stored in a temporal positional codebook, and wherein the spatial distances are stored in a spatial positional codebook.

7. The method of claim 1, wherein one of the plurality of tokens is randomly selected as a question token representing a classification objective and one or more of the plurality of tokens are selected as answer tokens representing classification outputs.

8. A computer system for performing a prediction task or a classification task comprising:
a processor set;
one or more computer-readable storage media; and
program instructions stored on the one or more computer-readable storage media to cause the processor set to perform operations comprising:
generating a plurality of tokens from a plurality of multi-channel inputs;
generating, via an encoder, a plurality of embeddings from the plurality of tokens; and
performing, via a multi-variate parallel attention model, the prediction task or the classification task based on the plurality of embeddings, wherein the multi-variate parallel attention model is configured to determine a time-based attention, a channel-based attention, and a content-based attention in parallel.

9. The computer system of claim 8, wherein the plurality of multi-channel inputs includes multi-channel time series data, and wherein generating the plurality of tokens comprises:
dividing the plurality of multi-channel inputs into a plurality of temporal windows each including a subset of the plurality of multi-channel inputs associated with a time;
dividing each of the plurality of temporal windows into a plurality of segments each associated with a channel represented in the plurality of multi-channel inputs; and
processing, via a feature extraction technique, the plurality of segments to generate the plurality of tokens.

10. The computer system of claim 8, the operations further comprising:
training the multi-variate parallel attention model to simultaneously perform the prediction task and the classification task, wherein the prediction task includes predicting one or more data points following the plurality of multi-channel inputs and the classification task includes classifying a category associated with the plurality of multi-channel inputs.

11. The computer system of claim 10, wherein training the multi-variate parallel attention model comprises:
summing the time-based attention, the channel-based attention, and the content-based attention to determine an attention value to train the multi-variate parallel attention model.

12. The computer system of claim 8, wherein the multi-variate parallel attention model includes a decoder and a multi-layer perceptron.

13. The computer system of claim 9, wherein the time-based attention is determined based on temporal distances between each of the plurality of segments and other segments of the plurality of segments, wherein the channel-based attention is determined based on spatial distances between each of the plurality of segments and the other segments, wherein the content-based attention is determined by applying a self-attention mechanism to the plurality of segments, wherein the temporal distances are stored in a temporal positional codebook, and wherein the spatial distances are stored in a spatial positional codebook.

14. The computer system of claim 8, wherein one of the plurality of tokens is randomly selected as a question token representing a classification objective and one or more of the plurality of tokens are selected as answer tokens representing classification outputs.

15. A computer program product for performing a prediction task or a classification task, the computer program product comprising:
one or more computer-readable storage media; and
program instructions stored on the one or more computer-readable storage media to perform operations comprising:
generating a plurality of tokens from a plurality of multi-channel inputs;
generating, via an encoder, a plurality of embeddings from the plurality of tokens; and
performing, via a multi-variate parallel attention model, the prediction task or the classification task based on the plurality of embeddings, wherein the multi-variate parallel attention model is configured to determine a time-based attention, a channel-based attention, and a content-based attention in parallel.

16. The computer program product of claim 15, wherein the plurality of multi-channel inputs includes multi-channel time series data, and wherein generating the plurality of tokens comprises:
dividing the plurality of multi-channel inputs into a plurality of temporal windows each including a subset of the plurality of multi-channel inputs associated with a time;
dividing each of the plurality of temporal windows into a plurality of segments each associated with a channel represented in the plurality of multi-channel inputs; and
processing, via a feature extraction technique, the plurality of segments to generate the plurality of tokens.

17. The computer program product of claim 15, the operations further comprising:
training the multi-variate parallel attention model to simultaneously perform the prediction task and the classification task, wherein the prediction task includes predicting one or more data points following the plurality of multi-channel inputs and the classification task includes classifying a category associated with the plurality of multi-channel inputs.

18. The computer program product of claim 17, wherein training the multi-variate parallel attention model comprises:
summing the time-based attention, the channel-based attention, and the content-based attention to determine an attention value to train the multi-variate parallel attention model.

19. The computer program product of claim 15, wherein the multi-variate parallel attention model includes a decoder and a multi-layer perceptron.

20. The computer program product of claim 16, wherein the time-based attention is determined based on temporal distances between each of the plurality of segments and other segments of the plurality of segments, wherein the channel-based attention is determined based on spatial distances between each of the plurality of segments and the other segments, wherein the content-based attention is determined by applying a self-attention mechanism to the plurality of segments, wherein the temporal distances are stored in a temporal positional codebook, and wherein the spatial distances are stored in a spatial positional codebook.
